(19) United States
(12) Patent Application Publication
(10) Pub. No.: US 2016/0336772 A1
(43) Pub. Date: Nov. 17, 2016

(54) CHARGING APPARATUS AND METHOD FOR ELECTRICALLY CHARGING ENERGY STORAGE DEVICES

(71) Applicant: SKYSENSE, INC., San Diego, CA (US)

(72) Inventors: Michele DALLACHIESA, Trento (IT); Andrea PUIATTI, Berlin (DE); Stefan KNORR, Berlin (DE); Leo PUIATTI, Trento (IT)

(21) Appl. No.: 15/111,438

(22) PCT Filed: Jan. 19, 2015
(86) PCT No.: PCT/EP2015/050901

§ 371 Date: Jul. 13, 2016

Related U.S. Application Data
(60) Provisional application No. 62/090,694, filed on Dec. 11, 2014.

(30) Foreign Application Priority Data
Jan. 17, 2014 (DE) 10 2014 100 493.0

(51) Int. Cl. H02J 7/00; B60L 11/18

(52) U.S. Cl. CPC H02J 7/0026; H02J 7/0045; B60L 11/1818; B60L 11/1838; B60L 11/1835; B60L 2200/10; B60L 2230/10

(57) ABSTRACT

A charging apparatus for electrically charging rechargeable battery cells (2) of a mobile consumer (1) comprises a plurality of area-wise distributed primary contacts (3) which are insulated against each other and are connectable with at least two counter contacts (4), wherein the primary contacts (3) are connected with a control unit (5) and electrical switches (6) for wiring into a right polarity for the charging process.

### FIELD OF INVENTION

The present invention concerns a charging apparatus, a method for electrically charging energy storage devices and a system for electrically charging energy storage devices of a mobile consumer. The present invention is especially applicable for charging mobile consumers like for example unmanned aerial or ground vehicles.

### BACKGROUND OF THE INVENTION

Usually two devices are electrically connected via a cable and a plug with a defined pin assignment. In other cases contacts are used which are located directly at a surface of the device. Such setup needs an additional mechanical arrangement for exactly aligning the contacts of one device with regard to contacts of the other device. Examples are the charging tray of a mobile phone or the charging station of a vacuum cleaner or of a lawnmower robot.

In addition to charging based on direct mechanical and electrical contact between a charging station and a consumer contactless charging methods are known which are based on the principal of electrical induction.

U.S. Pat. No. 8,511,606 B1 discloses a method and an apparatus for charging batteries in unmanned aerial vehicles wherein transmission of electrical energy from the charging station to the battery of the aerial vehicle is inductive. U.S. Pat. No. 7,543,780 B1 discloses a further method for charging unmanned aerial vehicles wherein the air vehicle includes charging contacts for energy transmission from energy transmission lines.

It is in object of the invention to provide a method and an apparatus for charging battery cells of mobile consumers reliably and effectively at low effort.

### SUMMARY OF THE INVENTION

The object is solved by claim 1 and claim 13, respectively. Beneficial modifications of the invention are defined in dependent claims.

In accordance with one aspect of the present invention there is provided a charging apparatus for electrically charging rechargeable battery cells of a mobile consumer, comprising a plurality of area-wise distributed primary contacts which are insulated against each other or against neighboring primary contacts (3) and are connectable with at least two counter contacts, wherein the primary contacts are connected with a control unit and electrical switches for wiring into a right polarity for the charging process. The mobile consumer may be an unmanned aerial or ground vehicle, a drone, UAV, multicopter or the like.

The charging apparatus may include that the primary contacts are charger contacts and the counter contacts are consumer contacts.

The charging apparatus may include that the consumer contacts comprise a point-like shape and wherein a thickness of the insulation between the extensive charger contacts is smaller than a diameter of the point-like consumer contacts.

The charging apparatus may include that the control unit comprises a micro processor which is connected with the electrical switches, a power supply and at least one of a half bridge, a current sensor and a light emitting diode.

The charging apparatus may include that the charging apparatus is a charger pad and the mobile consumer is a drone.

The charging apparatus may include means for at least one of cleaning, detection, attachment, marking and optical identification of an active area of the charging apparatus.

The charging apparatus may include that the primary contacts comprise a rectangle, square triangle, or hexagonal shape.

The charging apparatus may include that the mobile consumer includes a rectifier.

The charging apparatus may include that the primary contacts comprise different types of conductive tiles and wherein conductive tiles of one type are electrically connected to each other. For example, nine different types of conductive tiles or area-wise primary contacts or nine groups may be especially suitable for square conductive tiles and seven different types of conductive tiles or area-wise primary contacts or seven groups may be especially suitable for hexagonal conductive tiles. Besides the numbers of seven and nine, any number between two and the number of conductive tiles or area-wise primary contacts can be used.

The charging apparatus may include that the charging apparatus is a charger pad, wherein a wider charger pad is composed of a plurality of charger pads, wherein a charger pad comprises contact sockets and wherein bridging contacts connect the contact sockets. The contact sockets may be located at the border of the pads. Bridging contacts include contact bridges, cable connections, plug connections and the like.

The charging apparatus may include that the charger pad has a square or a rectangle, triangle or hexagonal shape with one contact socket arranged at the center of each side.

The charging apparatus may include a remote controlled enclosure adapted for enclosing a mobile consumer located on the charging apparatus

The charging apparatus may include that the remote controlled enclosure comprises two retractable roof parts.

The charging apparatus may include that at least one of the charger pad and the charger contacts consist of flexible material.

The charging apparatus may include that the consumer contacts are at least one of being movably mounted and being retractable.

In accordance with a further aspect of the present invention there is provided a method for electrically charging rechargeable battery cells of a mobile consumer comprising the steps of:
connecting at least two out of a plurality of area-wise distributed primary contacts which are insulted against each other with at least two counter contacts of the mobile consumer,
detecting of connected primary contacts which are to be activated,
activating of selected primary contacts and wiring of a charging voltage having the right polarity,
initiating and performing the charging process.

The method may include that the primary contacts are charger contacts and the counter contacts are consumer contacts and wherein detection of primary contacts which are to be activated is realized by monitoring of a current consumption such that
for a current flow below a set current range no charging process is initiated,
for a current flow above a set current range a charging process is initiated,
for a current flow above (overload) a set current range it is switched to a next configuration of contacts.
determining the completion of the charging process.

The method may include that the primary contacts are charger contacts and the counter contacts are consumer contacts and the detection of the full charge of the battery cells is realized by monitoring the derivative value of the current consumption. During the charging of the battery, the derivative value decreases. When the battery is fully charged, the derivative value approaches zero. For a derivative value below a set threshold the charging process is considered completed. Furthermore, the current consumption may be pre-processed using a moving average filter before computing the derivative values to level out noise and anomalies.

In accordance with a further aspect of the present invention there is provided a system for electrically charging a battery of a mobile consumer comprising a charging apparatus as described before, a battery charger, and a power supervisor adapted for managing power supply from the charging apparatus and the battery to the mobile consumer and/or for monitoring at least one the battery, the charging apparatus, the battery charger, and the mobile consumer. The power supervisor may be at least one of a control unit, a monitoring unit, a computer, a micro processor and a software program or routine.

Coordination of the geometry secures in all cases electrical contact between both devices for adequate wiring of the area-wise distributed primary contacts. In other words: the geometries of the area-wise distributed or extensive primary contacts and of point-like counter contacts are adapted such that electrical contact is made independently of the relative location and orientation of the both devices. This means that at least two independent electrical connections exist between both devices at all time. Which connections these are is determined by the control unit. The wiring of the electrical contacts is arranged accordingly.

In the following the device having the area-wise distributed primary contacts is designated as device A. While the device with point-like counter contacts is designated as device B. Device A has at least one region (active area) in which the area-wise distributed primary contacts are arranged. The individual contact areas are insulated against each other. The thickness of the insulator is smaller than a nominally diameter of the point-like counter contact. This ensures reliable electrical contact even when the point-like counter contact is positioned exactly between two area-wise distributed primary contacts.

Device A may include in addition to the electrical circuit and the active area further passive components which may be used for assembly, transportation, orientation, cleaning, detection or securing. Device A may also include further electrical active components which only indirectly participate for the electrical connection with device B. This may include components which provide a high contrast and may be utilized to mark and optically identify or detect the active area. Identification is made by a user of the connection system like a user (operator) or an autonomous vehicle which is equipped with a camera. Such a marking system may be passively implemented by different color markings or by illumination (for example permanent illumination or modulated (brightness, frequency, color, etc.) illumination for easy unidirectional communication from device A to its users) or a combination of both. Basic communication may include information regarding the status of device A like for example “ready for connection”, “already connected with our device”, “out of operation”.

The different extensive primary contacts of device A are connected by cables with connectors of the electrical circuit of A. The connectors are arbitrary electrical connections which are permanent (soldering, plugs with insulation displacement) or detachable (plug-in connector). Device A includes a control unit which is connected with several electrical switches. These switches enable the control unit to connect the connectors with different electrical signals like for example ground, supply voltage, communication channel send, communication channel receive. These switches are based on adequate technologies like for example relays, reed relays, transistors (NPN, PNP, MOSFET or others) or further switching technologies. A half bridge is destined for the wiring of the connectors with only two electrical signals. A similar switching structure like for example two half bridges may be chosen for the wiring of the connectors having several signals.

The inventive solution allows to connect two electrical devices and to transfer electrical energy from device A to device B or vice versa. The system guarantees establishment of an electrical contact and is almost independent from the positioning of the devices to each other. It is therefore useful for charging of autonomous drones on a charging station wherein the drone may land somewhere on the large contact area so as to start the charging operation.

It is a particular advantage of the invention that a contact is even then realized when no exact positioning between the primary contact and the counter contact occurs. This is achieved by several area-wise distributed primary contacts which are insulated against each other and are connectable with at least two counter contacts and by primary contacts which are connected with a control unit and electrical switches to achieve a wiring with a right polarity for the charging operation.

The charging method may be based on the following method steps:
connecting of at least two primary contacts out of a plurality of area-wise distributed primary contacts which are insulated against each other with at least two counter contacts of a mobile consumer,
identifying the connected and to be activated primary contacts,
activation of the chosen primary contacts and applying the charging voltage in the right polarity,
starting and performing the charging operation.

In the following the invention is described as a special version of the general solution namely for the charging process of drones. Here, the charging station represents the device A and the drone represents device B, i.e. the mobile consumer.

The electrical circuit of the charging apparatus includes a micro processor which provides the functionality of the charging apparatus and controls the electrical switches. The micro processor identifies the landed drone and applies the charging voltage with right polarity to the respective contacts of the drone. Besides being connected with the electrical switches the micro processor is connected with further components: power supply (12 V DC), MOSFET-based half bridges, a current sensor, LED's. The p-channel-MOSFETs of the half bridge are switched by additional NPN transistors. The n-channel-MOSFETs are directly switched by switching outputs of the micro processor. The electrical circuit may for example be connected with a maximum of sixteen different contacts of the active area. That way, the charging voltage may be connected with the two contacts of the active charging areas in 240 (16*16−16) different configurations. The micro processor enables switching from one configuration in another within a few micro seconds. A configuration is here defined as the assignment or correlation of different primary contacts to each other, i.e. electrical connection of two or more primary contacts or charger contacts.

The method of identifying and charging of drones includes the following: the micro processor permanently monitors the power consumption of the connected half bridges. The different configurations are switched subsequently. This allows matching of measured currents to the configurations. These currents are classified:
no electrical load,
charging circuit of a drone,
overload.

The currents enable an identification of different loads between the different charging contacts. Once a charging circuit is identified the charging current is supplied to the corresponding contacts in right polarity. Once an overload is identified the control unit switches further to the next configuration. The LED's show the actual status of the electrical circuit.

The landing platform of the charging apparatus consists for example of flat aluminum contact areas having a hexagonal or rectangular shape. The contacts are connected such that only a small gap of a maximum of five millimeters is present between them. All contact areas have the same shape. The connection with the electrical circuit is achieved by riveting the cable. Each two contact areas are connected with each other. The complete active area may therefor be arranged to an arbitrary shape.

The mobile consumer, here a drone, includes four point-like consumer contacts (dampened measuring contacts, arranged at corners of a square) which are located at the bottom side of the drone. Two diagonally opposed consumer contacts are (electrically) connected with each other and each pair is connected to the power supply of a charging circuit. The charging circuit is connected with the battery of the drone. Once the consumer contacts of the drone are connected with the required charging voltage the charging operation starts.

The electrical circuit may control more than one charger pad. The charger pad is defined as a delimited geometric area of the charging apparatus which is provided with extensive charging contacts.

The electrical circuit and the drone may communicate unidirectional or bidirectional (wireless, optical or via the electrical charging contacts, power line communication). This way, the charger pad detects or identifies the landing or landed drone. This identification may be used to
record the charging activity of the platform;
limit charging to certain drones, for example by explicit identification;
to limit charging to certain drones, wherein limitation is provided by another system (for example user specifications);
adapt charging to a specific drone, for example adapting the charging voltage corresponding to the electrical circuit of the drone (4 V or 12 V charging voltage for single-celled or multi-celled batteries).

The charger pad may comprise flexible electrical charging contacts which are connected to a flexible based material as for example stainless steel grids or stainless steel nets as electrical contacts on a textile PVC tarpaulin. Such a flexible platform offers the following advantages:
low deadweight compared to a stiff structure;
the platform is flexible and may be rolled up or folded to a small pack size. This is suited especially for temporary use or use in areas in which a stiff structure is set up only with difficulty;
the base material may be printed with particular patterns which are visible through the transparent contacts.

Such a platform may be fixed to the ground with nails, ropes, weights or other means. The platform may be spread out within a rigid frame. The platform itself may include chambers which may be filed with liquids or gases. The weight may be temporarily increased by using a liquid so that a secure foothold is achieved. Gas filling provides a self-stable platform which behaves like a rigid platform. The drone may include a rectifier (for example a diode rectifier). Then, the drone may be charged by the charging station with arbitrary polarity. This offers two imminent advantages:
reduction of the number of possible configurations (current path through two charger contacts),
two different drones can be charged on the same platform without restriction.

The charge contacts may be moveably mounted and could be retracted or folded. Further, the charger contacts may easily be exchanged. The number of contacts of the drone may be more or less than four. For applications in general it may be of interest to reverse the above mentioned principle of a charging station having extensive contacts and a mobile drone having point-like contacts. In such case the charging station includes two or more point-like contacts and the mobile device includes extensive contacts as well as the control unit and the electric switches. In such case the charging station may be produced very inexpensively and is in the simplest case only a current supply.

A charger pad may comprise a tessellation of conductive tiles. Charger pads can be combined into a wider charger pad by using socket contacts and bridge contacts. The bridge contacts may be used to connect socket contacts on different charger pads. Embodiments of the present invention may include: 1) a charger pad, 2) a power supervisor, and/or 3) a remote-controlled enclosure. Embodiments of the present invention can be applied to any mobile electrical device. UAVs/drones/multicopters are a possible embodiment of such a device.

The UAV/drone/multicopter may include a battery charger. The battery charger may also be an external add-on that extends the drone's capabilities.

Certain embodiments of the present invention may be directed to a charger pad for charging UAVs/multicopters/drones. Certain embodiments of the present invention may be directed to a method of charging devices such as, for example, UAVs, multicopters, and/or drones. Certain embodiments of the present invention may be directed to a method of manufacturing a charger pad.

In certain embodiments of the present invention, the mobile electrical device can be a drone, UAV, and/or a multicopter.

### BRIEF DESCRIPTION OF THE DRAWINGS

The invention is explained in the following in conjunction with embodiments depicted in the figures.

FIG. 1 is a schematic diagram of parts of the charging apparatus;

FIG. 2 is a schematic diagram of parts of a mobile consumer;

FIG. 3 shows the distance between two contacts of the drone;

FIG. 4 shows the distance between several contacts of the drone;

FIG. 5 shows a preferred embodiment of the charging area with hexagonal charger contacts;

FIG. 6 shows the landing pad of the drone with two consumer contacts;

FIG. 7 shows the arrangement of four contacts on a drone;

FIG. 8 shows the landing area of the drone with four consumer contacts;

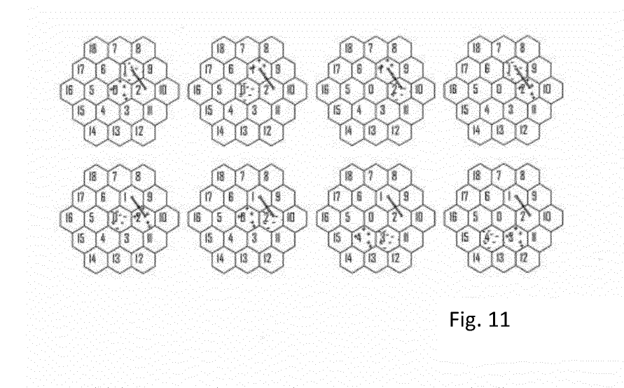

FIG. 9 shows an example of the detection of a drone,

FIG. 10 shows further examples of contacting options;

FIG. 11 shows an example of contacting options reducing possible combinations;

FIG. 12 shows a principle wiring of a primary contact;

FIG. 13 shows an embodiment of a main switch;

FIG. 14 shows an example of a half bridge;

FIG. 15 illustrates an example of bottom surface in accordance with certain embodiments of the present invention;

FIG. 16 illustrates a socket with 9 contacts, in accordance with certain embodiments of the present invention;

FIG. 17 illustrates an example of using redundant wiring in accordance with certain embodiments of the present invention;

FIGS. 18 and 19 illustrate a wider charger pad according to certain embodiments of the present invention;

FIGS. 20, 21 and 22 illustrate the surface of the charging pad from top in different arrangement of the square;

FIG. 23 illustrates an embodiment which implements 9 groups of connected conductive tiles;

FIG. 24 illustrates a drone with a plurality of legs landing on the charger pad;

FIG. 25 shows nine contacts on the left side of the square of a charging pad;

FIG. 26 illustrates an example configuration of redundant wiring according to certain embodiments of the present invention;

FIG. 27 illustrates two charger pads that are connected using 9 contacts on the left and right sides of two charger pads;

FIG. 28 illustrates an example system in accordance with certain embodiments of the present invention;

FIG. 29 shows components and wiring of the system;

FIG. 30 illustrates an example of a remote-controlled enclosure;

FIGS. 31 and 32 show the structure of a remote-controlled enclosure designated as the Drone Port;

FIG. 33 shows an example of mechanics of the Drone Port;

FIG. 34 shows lateral views of the Drone Port;

FIG. 35 shows the drone port in a top view in open and closed position;

FIG. 36 shows the drone port in a front view in open and closed position;

FIG. 37 shows the Drone Port in its “Closed” position;

FIG. 38 shows the Drone Port in the “Opening/closing” position; and

FIG. 39 shows the Drone Port in the “Open” position.

### DESCRIPTION OF THE PREFERRED EMBODIMENTS

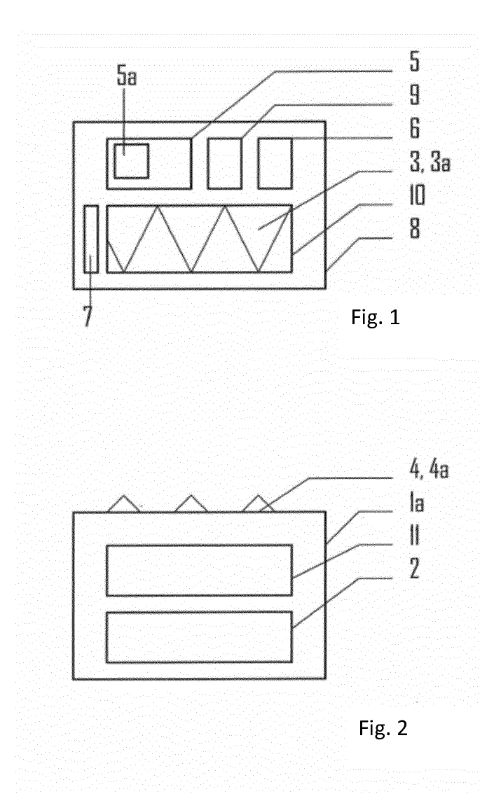

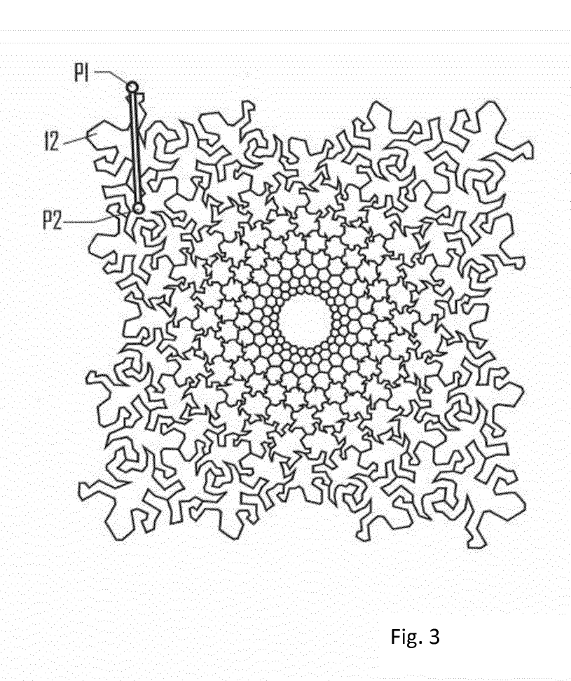

As shown in FIG. 1 the charging apparatus according to the invention includes a charger pad 8 with a control unit 5, an identification system 9, electric switches 6 and at least one active area 10 which is formed by several electrical contacts in form of primary contacts 3/charger contacts 3a. The drone 1 shown in FIG. 2 comprises point-like counter contacts 4a/consumer contacts 4 and includes a rechargeable battery with battery cells 2 as well as an optional charging circuit 11.

The coordination of the extensive primary contacts 3 of device A and the point-like counter contacts 4 of device D is important for the invention. It has to be ensured that by the wiring of the switches 6 in device A the charging circuit 11 is supplied with electrical energy. Especially it is to be avoided that the consumer contacts 4a of the drone 1a land on or contact on different electrical charger contacts 3a of the active charging area 10. If the drone 1a includes two consumer contacts 4a then the distance between the two consumer contacts 4a has to be larger than the major extension of a single contact area 12. This geometric parameter can be determined for each limited area. For a square for example it is the length of the diagonal.

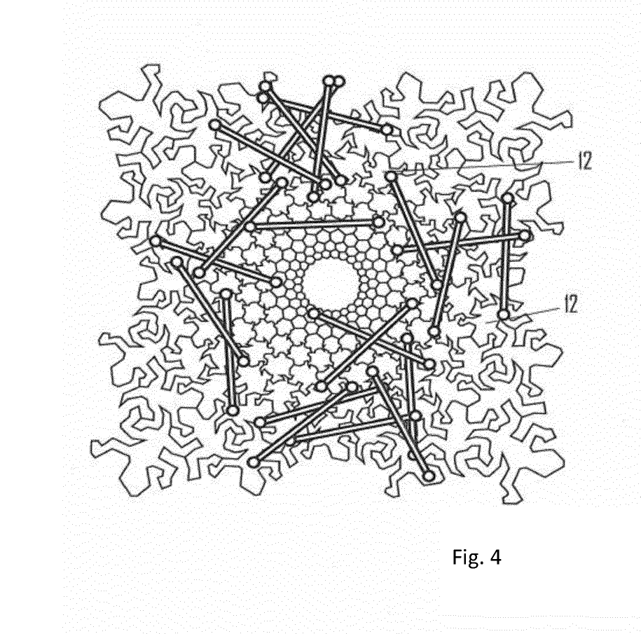

FIG. 3 shows the possible distance of two consumer contacts 4a compared with the largest contact area 12 of the charger contacts 3a. The points P1 and P2 show the diameters of both point-like consumer contacts 4a. A drone 1a having such consumer contacts 4a may land at an arbitrary position in an arbitrary orientation and will never contact the same contact area 12 with both consumer contacts 4a. The drone 1a may possibly short circuit two or more contact areas 12 but in any case the drone 1a can be charged by wiring of two different contacts. This geometrical adaptation can be performed even if more than two consumer contacts 4a are present at the drone 1a.

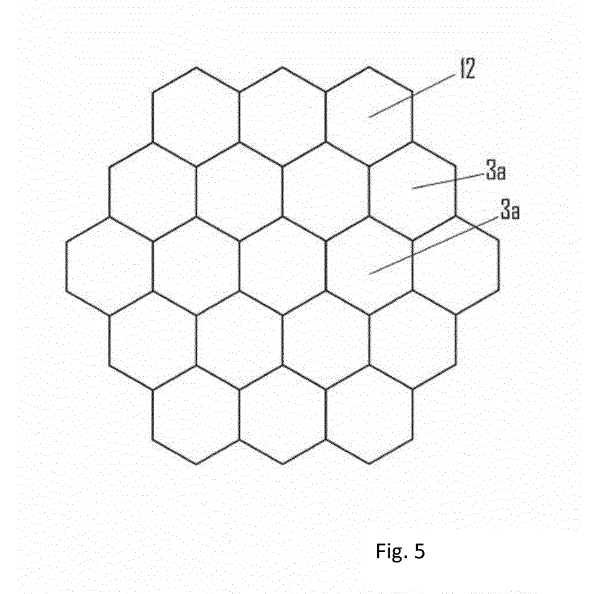

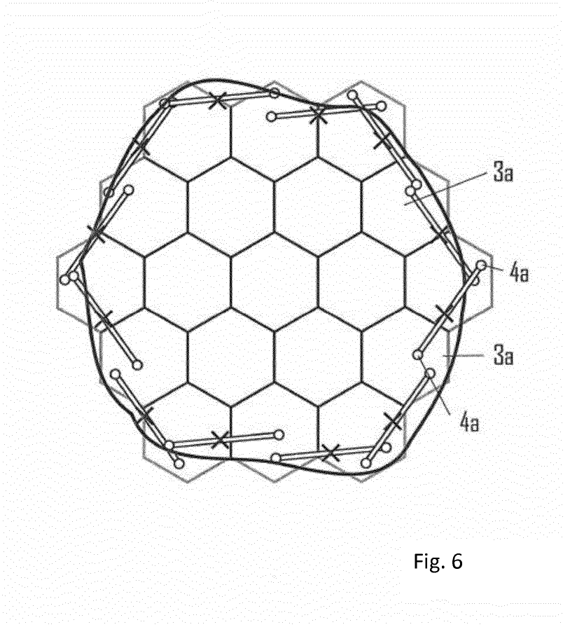

FIG. 4 shows further chosen possible positions of the consumer contacts 4a of the drone 1a on contact areas 12. For technical reasons it makes sense to use uniform contact areas because then the number of necessary contact areas 12 can be minimized for a give active landing pad. Thereby, the number of connection cables between the active area 10 and the switches 6 is also reduced. Preferred are equilateral polygons like for example equilateral triangles, squares or equilateral hexagons which are one preferred embodiment like depicted in FIG. 5. Here, preferably nineteen hexagonal charger contacts 3a with a respective contact area 12 are arranged.

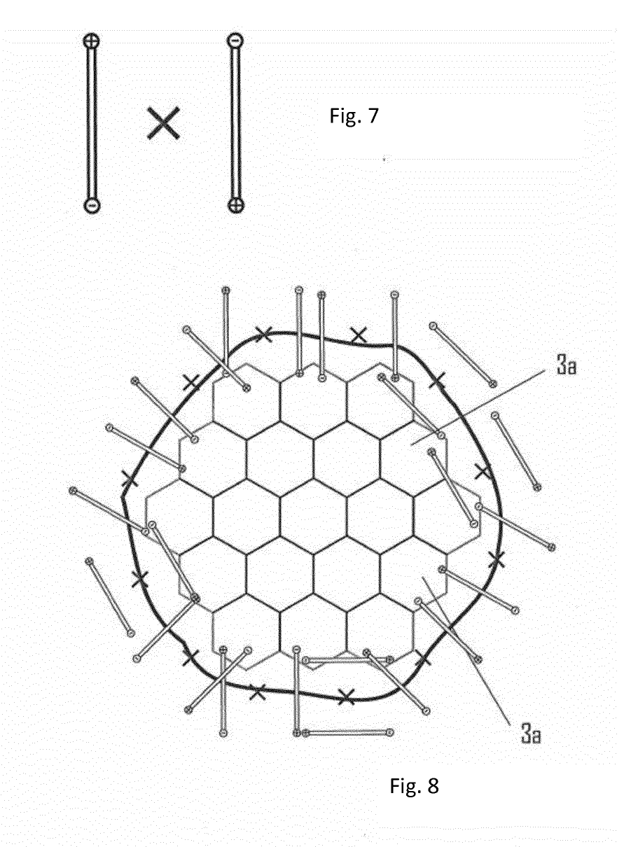

The size of the system can be scaled at discretion. The charger contacts 3a may have a size of several square meters for example for load carrying drones 1a. On the other hand, the charger contacts 3a may be implemented for micro drones 1a. In such case the contact areas 12 have the size of a few square millimeters or less. Having a given landing pad like depicted in FIG. 6 a certain landing area exists in which the drone 1a has to land in order to be charged.

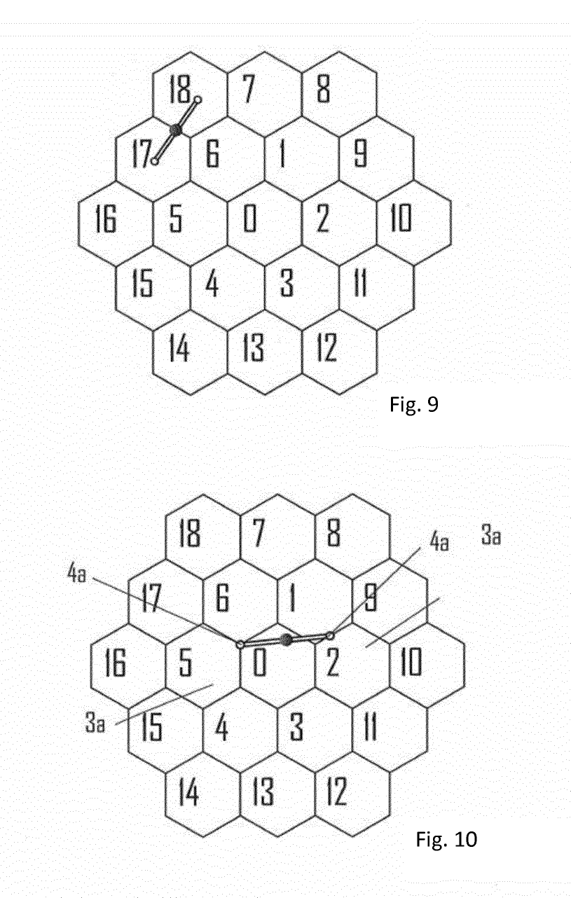

In FIG. 6 a drone 1a is shown which comprises two consumer contacts 4a. The area in which the drone 1a has to land to be charged is outlined. The cross in FIG. 6 is the center of the drone. In FIG. 6, the extreme possible landing positions are shown. In the central positions which are not shown the drone can be charged as well. In an alternative of the drone 1a as shown in FIG. 7 it is equipped with four consumer contacts 4a. Two of the consumer contacts 4a are connected electrically positive and the other two are connected electrically negative. In such configuration of the drone 1a the landing area is increased considerably for the same active area 10 when compared to FIG. 6.

The identification system or detection system 9 is used to detect the presence of a drone 1a on the charger pad 8. Several pieces of information may be used for detection for example
force, weight or acceleration sensor which determines the presence of a drone 1a.
communication methods between the drone and the charger pad 8 which may be implemented wireless or via the contact areas 12. Via such a communication line the drone 1a may transmit further information to the charging apparatus like user data (photos etc.), status information, progress of the charging action and the like.
optical information for example from a camera which is monitoring the charger pad 8.
a current sensor which determines the current consumption between two different contacts.

A current sensor may in its simplest form be a resistance sensor or a precision resistor wherein voltage is present across the sensor in proportion to the current. Alternatively, further methods for measuring the current like based on the Hall Effect or other methods may be used. Besides detecting the drone 1a the current sensor and the switches 6 may be used to determine with which charger contacts 3a the drone 1a is connected. To this end all possible combinations of wiring of two different charger contacts 3a are iterated. For example, plus to contact 0 and minus to contact 1, then plus to contact 0 and minus to contact 2 and so on (plus to 0, minus to 1//plus to 0, minus to 2//plus to 0, minus to 3).

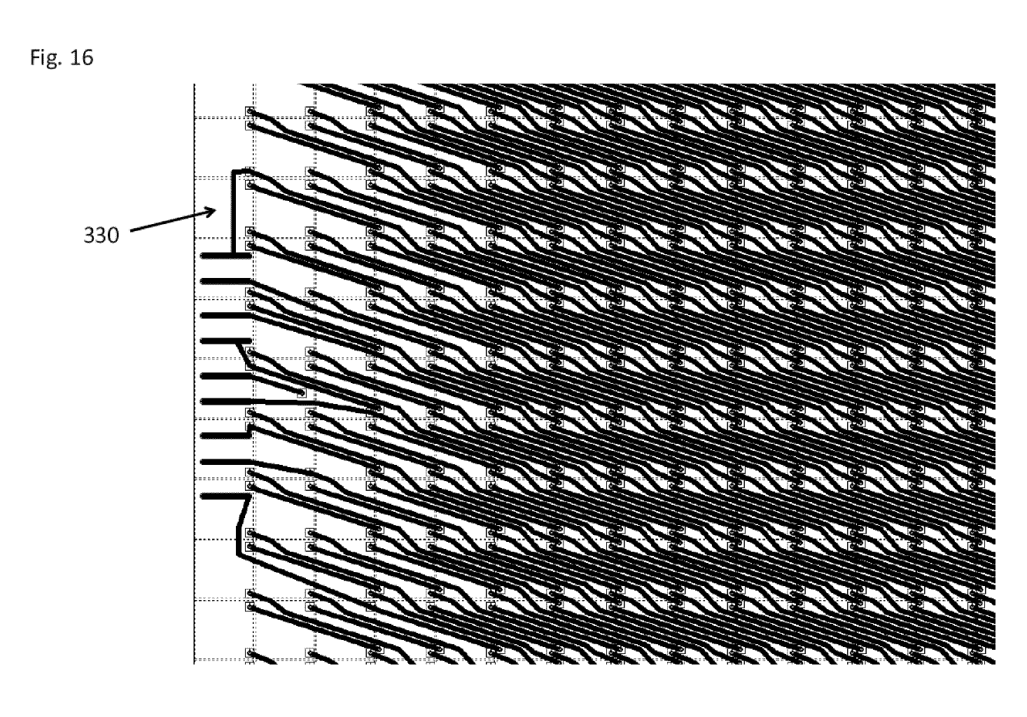

FIG. 12 shows the basic wiring of a charger contact 3a with a MOSFET half bridge. By controlling the gates of the transistors the potential of the charger contact 3a can be chosen.

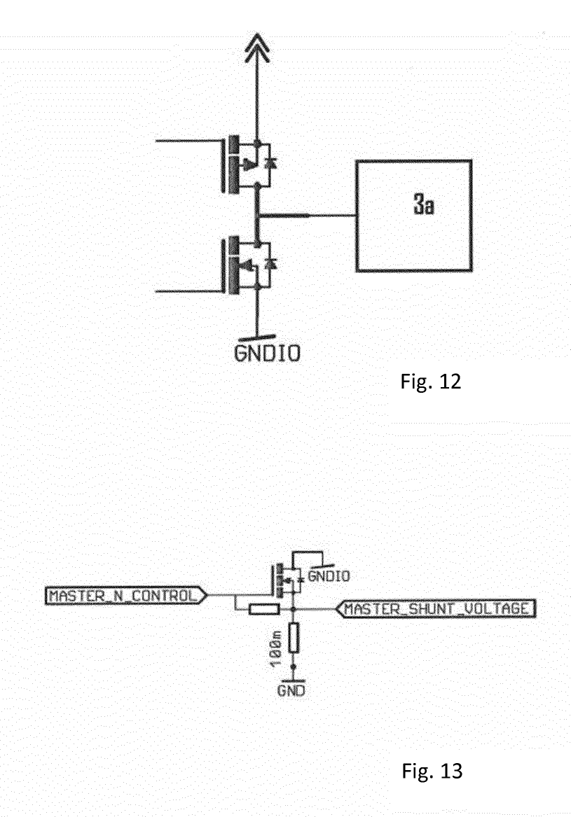

In the example depicted in FIG. 9 a drone 1a is detected between the charger contacts 17 and 18 because the measured current is there above a zero value or limit. A measurement from 17 (plus) to 18 (minus) provides for example a current consumption of 100 mA. From charger contact 18 (plus) to 17 (minus) a measurement provides only 1 mA which may be below a defined zero value. The drone 1a is subsequently charged by the combination 17 (plus) to 18 (minus) (abbreviated as 17->18).

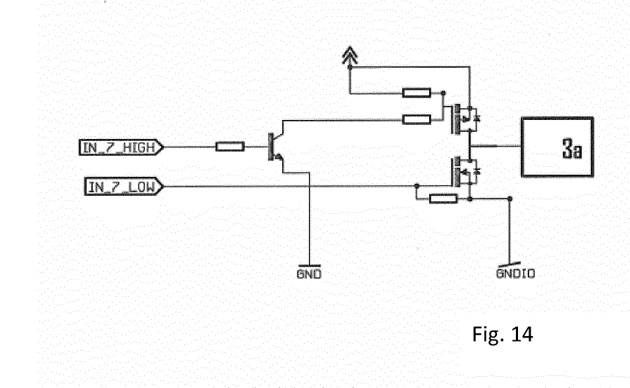

In the example shown in FIG. 10 the drone 1a contacts different contact areas 12 of the charger contacts 3a with its point-like consumer contacts 4a. During measurement the drone 1a is detected between different pairs of contacts (5->2, 6->2, 0->2, 5->1, 6->1, 0->1). Further, different short circuits are detected (5->6, 6->5, 0->6, 6->0, 0->5, 5->0, 1->2, 2->1) for which the current consumption is higher than a threshold value of for example 1000 mA. The drone 1a is then charged via one of the following combinations: 5->2, 6->2, 0->2, 5->1, 6->1, 0->1.

A state of the battery and a state of charge can be monitored using the current monitoring for a known battery and a known charging circuit of the drone.

An algorithm for the control may be as follows:
examining with the identification system 9 whether a drone 1a has landed and which contacts are needed for charging. Initiation of the charging by corresponding wiring of the involved contacts. Monitoring of the charging procedure by current measurement.
ignoring possible short circuits between further contacts 3a.
depending on the size of the charger pad 8 detection of further drones 1a may take place during charging of one or more drones 1a until the overall charging capacity of the system has been reached.

In a passive state the device A is not connected with device B. Sub components like the electrical switches 6, the identification system 9 and the control unit 5 are connected with each other so that an overall operation of the system is ensured. Since the sub components are arranged close to each other a direct electrical connection is preferred. A wireless communication between these devices is also possible for example by optical communication or radio communication. In a preferred embodiment all components are arranged on one electrical circuit board. The connection between the electrical switches 6 and the one or more active areas 10 is realized by cables which may have any length but preferably have a length smaller than 10 meters. For small systems, the structure of one or more active areas 10 may be implemented directly on a circuit board.

Device A is operable and tries to detect with its identification system 9 a device B. In case of current monitoring the different charger contact areas 3a are switched by the switches 6 to different electrical potentials.

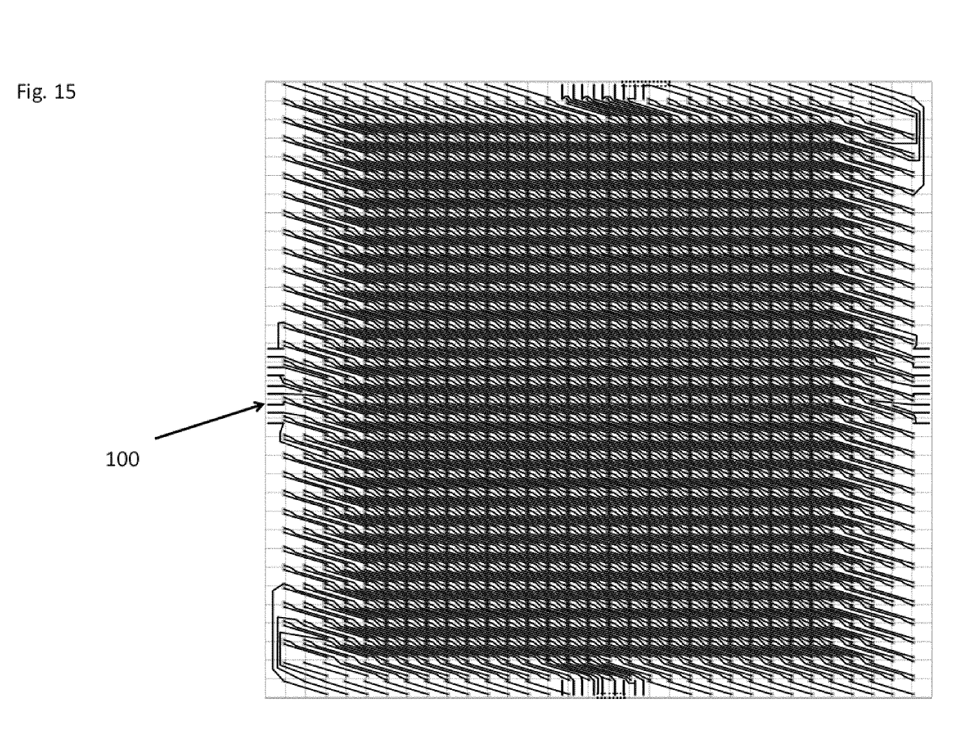

If for example two contacts of device B are connected to contacts 1 and 2, then an expected current which corresponds to the charging current of connected device B is measured during testing of all possible combinations (in total 342 combinations for 19 different contacts). In FIG. 11 eight different combinations are exemplarily depicted. The plus and minus signs characterize the different electrical potentials. The fourth combination (top right) is the only one that delivers a current consumption. All other combinations have to be tested though as the device could also be connected with another pair of contacts.

The number of 342 in this example may be reduced in case the mechanical configuration is known. It is for example impossible that device B in the chosen configuration according to FIG. 11 is connected with contacts 10 and 16. The same holds true for further contacts.

When a device A is connected to several active areas 10 of the charger contacts 3a the number of switch combinations to be tested can be reduced during the search for devices B. Here, three active areas 10 with 19 contacts each connected to device A delivers 3192 different combinations. If, due to the geometrical layout or due to the intended use, connection of a device B with different active areas 10 does not occur the number of combinations can be reduced to 3×342. For a current measuring based identification system 9 it may be reasonable (but not necessary) to provide an own identification system 9 for each active area 10. A dedicated current sensor may for example be integrated in each of the three supply lines of the three active areas 10 of the charger contacts 3a. Each of the current sensors is then connected to the control unit 5.

In the simplest case the device B is as depicted in FIG. 2 an electrical consumer having rechargeable battery cells 2 possibly paired with an adequate charging circuit 11 and at least two consumer contacts 4a. An input of the charging circuit 11 is electrically connected to the consumer contacts 4a and is adapted to instantly initiate the charging process when device B is provided via the contacts 4a with the correct (current, voltage) electrical energy.

If device B includes further electrical components (control unit 5, electrical switches 6, status sensors) these accomplish in a passive state a function. In case of a communication between device A and device B via electrical contacts 4a and 3a device A will for example permanently try to transmit a message to device B. Once contact between both devices occur device B is able to receive the message and can react accordingly.

If a device B is detected a current consumption of which (determined by impedance and the potential difference of the involved contacts) corresponds to a typical current consumption of device B contact between device B and the contacts is specifically supervised. For most cases such contact is not established in a stable manner in the first moment after the identification. The consumer contacts 4a may contact different charger contacts 3a at different times due to a relative movement between device B and the charger pad 8.

Not until the state of contact between device A and device B is classified as stable, the detection is completed. The relative movements usually diminish within a few seconds. Due to external circumstances such relative movements may occur also during the actual charging process (accidental touch through device B or charger pad 8, intentional shift of device B with regard to charger pad 8, gust of wind, or the like). In this case device A starts again with a search process in order to detect device B again. The charging process is continued after the repeated detection.

Depending on the size and number of active areas 10 detection of further devices B may be reasonable during the charging process. All charger contacts 3a which participate at the current charging process are normally disregarded for the search.

In an active state of device B the charging circuit of device A is supplied with electrical energy via the active area 10 of the charger contacts 3a in conjunction with the consumer contacts 4a so that the cells 2 of the battery are charged.

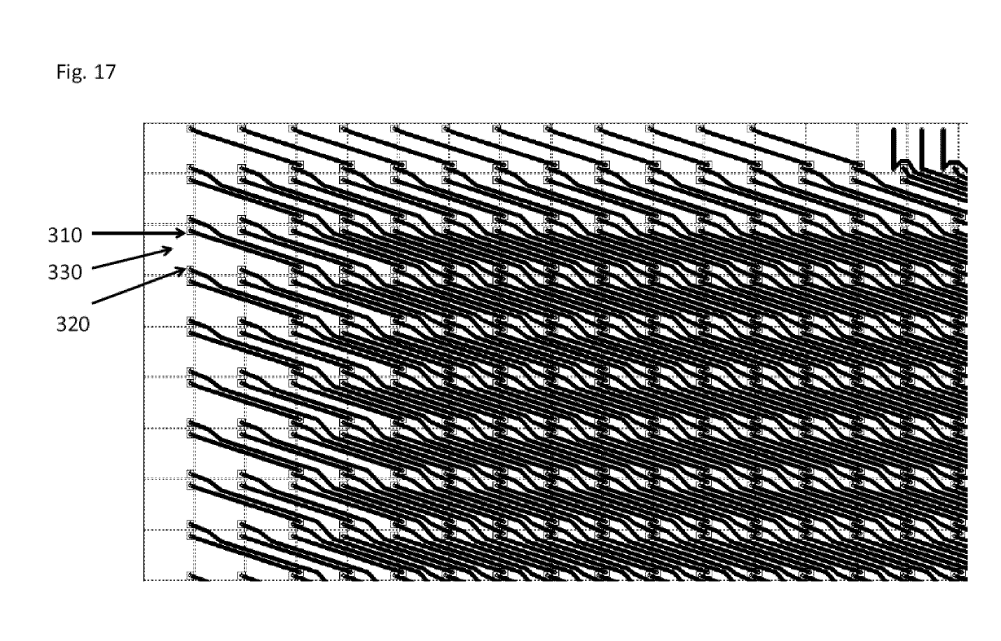

FIG. 13 shows two further components of an embodiment of the electric circuit. An n-channel-MOSFET serves as a main switch for all charger contacts 3a. Arranged below is a precision resistor (100 mOhm) for determination of the present current consumptions over the charger contacts 3a.

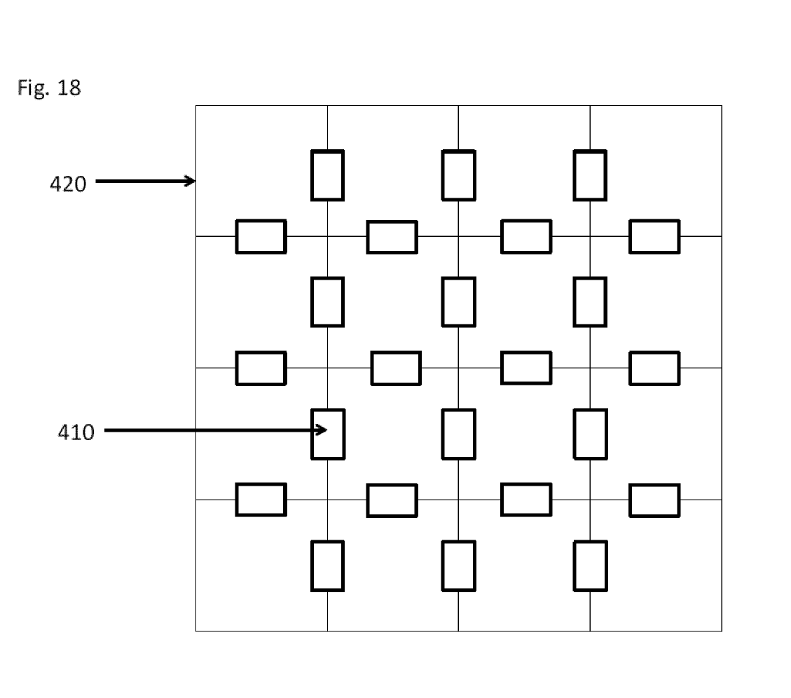

FIG. 14 shows the preferred embodiment of wiring of a MOSFET half bridge. The n-channel-MOSFET is wired with a resistor and can be controlled directly form a digital output of the micro controller. The p-channel-MOSFET is controlled via an additional NPN transistor. The base of the NPN transistor is connected to a digital output of the micro controller via a series resistance. The two resistors at the gate of the p-channel-MOSFET provide a limitation of the gate-source-voltage.

The micro controller may be connected with at least one further voltage supply in addition to the power supply. These additional voltage sources may provide a fixed voltage or may be controlled in their output voltages by the micro controller. A respective wiring allows for supply of different electric loads with different charging voltages.

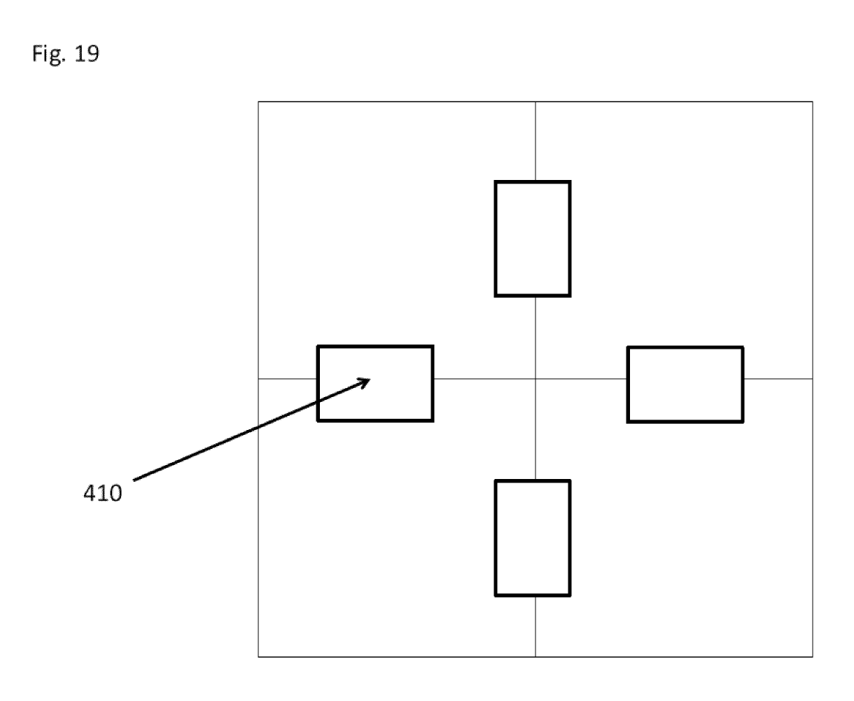

FIG. 15 shows for a certain embodiment of the present invention that the charger pad may also comprise a bottom surface. The bottom surface may contain the wiring that connects the conductive tiles in the same groups (i.e., conductive tiles of the same type) using vias to the top surface. FIG. 15 illustrates an example of bottom surface in accordance with certain embodiments of the present invention. FIG. 15 illustrates the bottom surface of a charger pad 100. A multiplicity of squares is used, in this example 33 by 33 squares, i.e. a total of 1.089 squares is utilized. A larger or smaller number of squares may be implemented. Each square corresponds to a charger contact and a primary contact, respectively. As an alternative, each square could be replaced by a hexagon, triangle, rectangle or any other geometric form allowing repetitive placement on the charger pad 100.

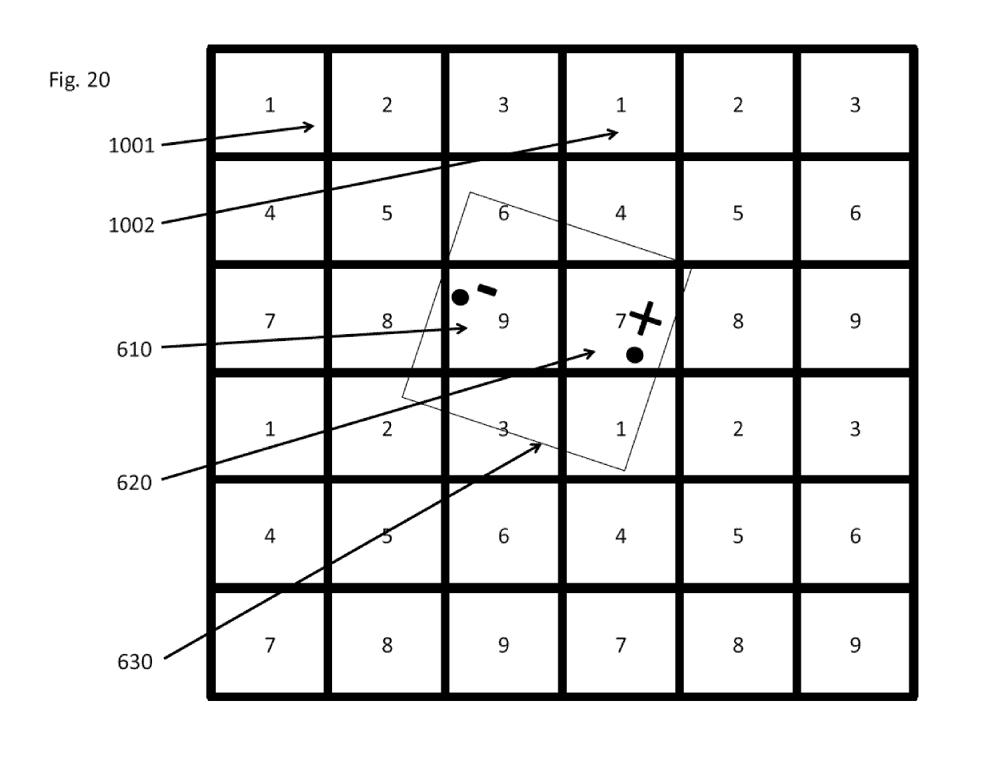

In one embodiment of the present invention, the charger pad or tile 330 may be a square, and there may be four contact sockets positioned at the center of each side of the charger pad. In one embodiment of the present invention, each socket may contain nine contacts. FIG. 16 illustrates a socket with nine contacts, in accordance with certain embodiments of the present invention. FIG. 16 depicts a partial view of the left side of FIG. 15. The nine contacts may correspond to nine different groups of squares or contacts as is shown later.

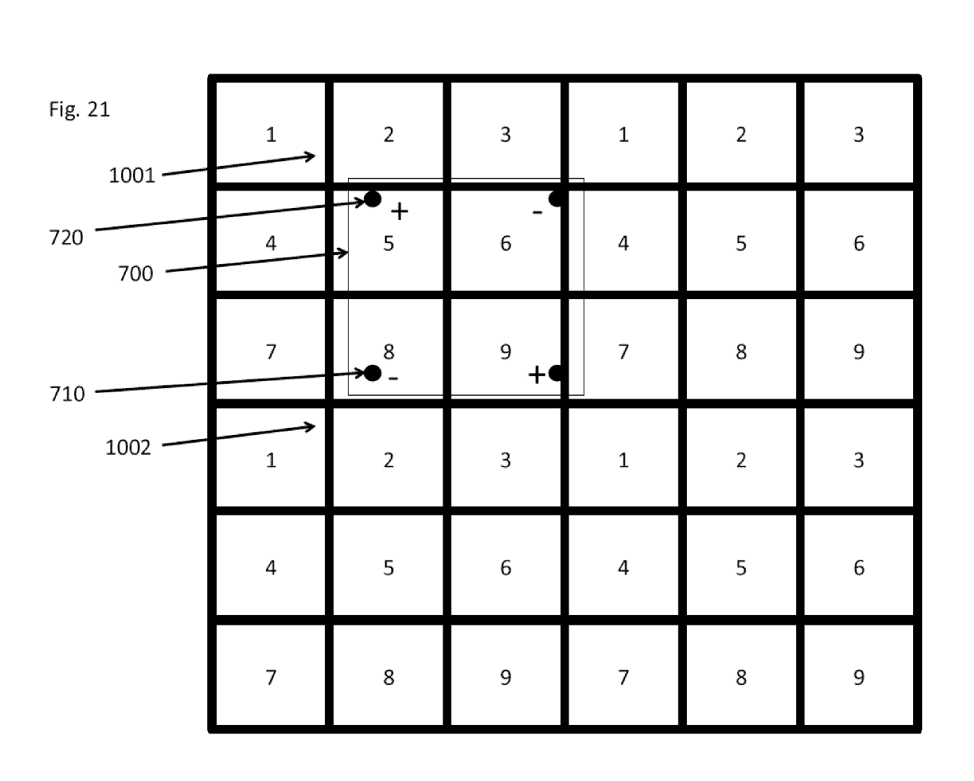

In certain embodiments, the bottom surface may utilize redundant wiring. The redundant wiring on the bottom surface may provide a greater maximum flowing current. In other words, a given conductive tile or square on the top surface may be reached through different conductive paths on the bottom surface. FIG. 17 illustrates an example of using redundant wiring on the bottom surface in accordance with certain embodiments of the present invention. FIG. 17 depicts a partial view of the upper left corner of FIG. 15. The conductive tile 330 is connected to the other tiles of the same type through the vias 310 and 320 on the bottom surface.

In certain embodiments of the present invention, the redundant wiring may be implemented using wires arranged in a diagonal pattern on the bottom surface. FIG. 17 illustrates an example.

With certain embodiments of the present invention, the use of an additional PCB layer may be used to protect the wiring contacts on the bottom surface.

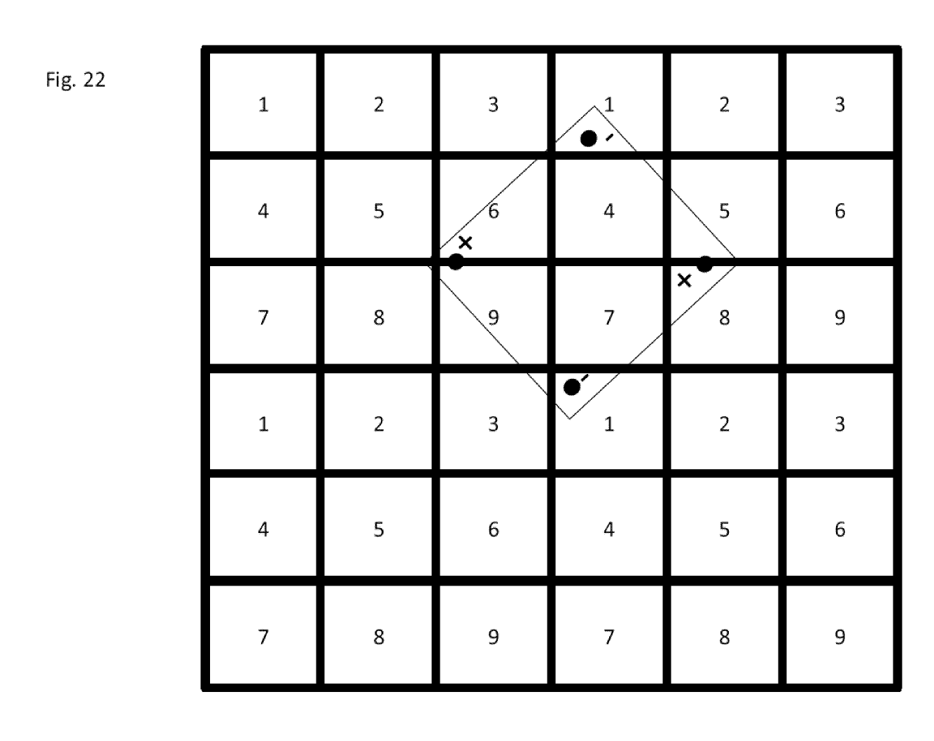

In certain embodiments of the present invention, multiple charger pads 100 as for example shown in FIG. 15 can be composed or consolidated into a wider charger pad 420. FIGS. 18 and 19 illustrate a wider charger pad 420 according to certain embodiments of the present invention. This embodiment may implement a varying number of charger pads composed/consolidated into a wider charger pad 420. Here, four or sixteen single charger pads are consolidated into one wider or extended charger pad 420. While wider charger pads having a square layout are shown other layouts like for example rectangular or irregular may be implemented.

Composability of multiple charger pads into a wider charger pad 420 may be made possible by (1) contact sockets positioned on a border of the charger pad, and (2) bridge contacts 410 that connect the socket contacts between neighboring charger pads, as illustrated by FIGS. 18 and 19. An example of a bridge contact 410 is depicted. The bridge contacts 410 include electrical connectors compatible to contact sockets of the charger pad as for example shown in FIG. 15.

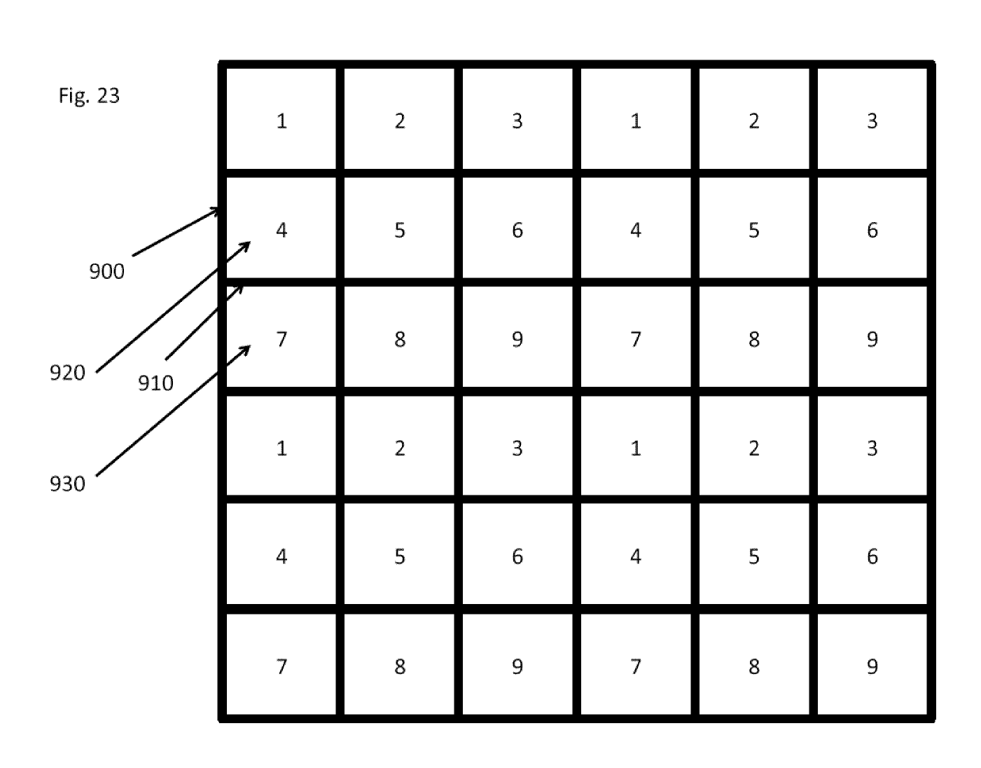

In certain embodiments, at least one leg of the plurality of legs of the drone may correspond to a square 630 as shown by FIG. 20. Each square 630 may have a plurality of battery charger input contacts, for example two as shown by FIG. 20. It is also possible that only one contact is provided per leg. In such case two legs provide the complementary, i.e. plus and minus, contacts.

FIG. 20 shows an upper side or surface of the charger pad. The charger pad has six by six, i.e. thirty-six, squares or tiles. The tiles are classed into nine different types and are designated accordingly with numbers from one to nine. FIG. 20 shows either one charger pad with thirty-six squares (contacts) or four grouped charger pads with nine squares each. Squares 1001 and 1001 are representative of group 1 and are electrically connected as shown for example in FIG. 17.

Each square 700 may have a plurality of battery charger input contacts, for example four as shown by FIG. 21.

In certain embodiments of the present invention, the electrical mobile device may not include a plurality of legs. In some embodiments, the battery charger input contacts may correspond to a square 700 as shown by FIG. 21 installed on the exterior surface of the electrical mobile device. In some embodiments, the battery charger input contacts may correspond to a square 630 as shown by FIG. 20 installed on the exterior surface of the electrical mobile device.

In certain embodiments of the present invention, redundant input contacts 710, 720 of the battery charger can be introduced to improve reliability and to provide a greater maximum flowing current. In one embodiment, two pairs of two input contacts of the battery charger may be used. The input contacts may be aligned at the corners of a square 700 wherein the sides of the square are larger than each diagonal of each conductive tile of the charger pad, as illustrated by FIG. 21.

FIG. 22 shows the drone in another position and orientation on the pad. In certain embodiments of the present invention, the diameter of the input contacts of the battery charger may be larger than the gap between the conductive tiles. Although shorting between two or more tiles may possibly occur, shorting never occurs between conductive tiles that are connected to different battery charger input contacts.

When the mobile electrical device (such as the UAV/multicopter/drone, for example) is positioned on the charger pad, the input contacts of the battery charger are electrically connected to at least a pair of conductive tiles on the top surface of the charger pad, as illustrated by FIGS. 20, 21 and 22, for example.

In one embodiment of the present invention, when using square tiles, the maximum distance between any pair of points of a given square is equal to the diagonal length of the square.

In certain embodiments of the present invention, redundant input contacts of the battery charger (on the exterior of the enclosure of the electrical device) may be useful to provide a greater maximum flowing current. In other words, a battery charger input contact may be reached through different conductive tiles on the top surface. The minimum distance among the contacts (of the electrical device) may be configured to be greater than the maximum distance between any pair of points on a given conductive tile. By using such a configuration, input contacts of different polarities will not be in contact with a same conductive tile.

In certain embodiments, all input contacts may be at a distance greater than the maximum distance between any pair of points on a given conductive tile. With squared conductive tiles, input contacts with different polarity may be at a distance smaller than two times the length of the side of each conductive tile to ensure that shorts of input contacts with different polarity cannot occur. With a different shape of conductive tiles, the maximum distance between contacts of different polarity may be different.

Certain embodiments of the present invention may be directed to a method of manufacturing a charger pad. The method of manufacturing may comprise manufacturing multi-layered Printed-Circuit Boards (PCBs). In one embodiment of the present invention, the charger pad can be implemented by a PCB with two layers. The top layer of the PCB may implement the top surface of the charger pad, as illustrated by FIGS. 20, 21 and 22, for example. The bottom layer of the PCB may implement the bottom surface of a charger pad, as illustrated in FIG. 15.

According to certain embodiments of the present invention, the charger pad may have four PCB layers: (1) the 1st layer may comprise the square tiles, (2) the 2nd layer may comprise horizontal connections, (3) the 3rd layer may comprise vertical connections, and (4) the 4th layer may comprise the bridge contacts.

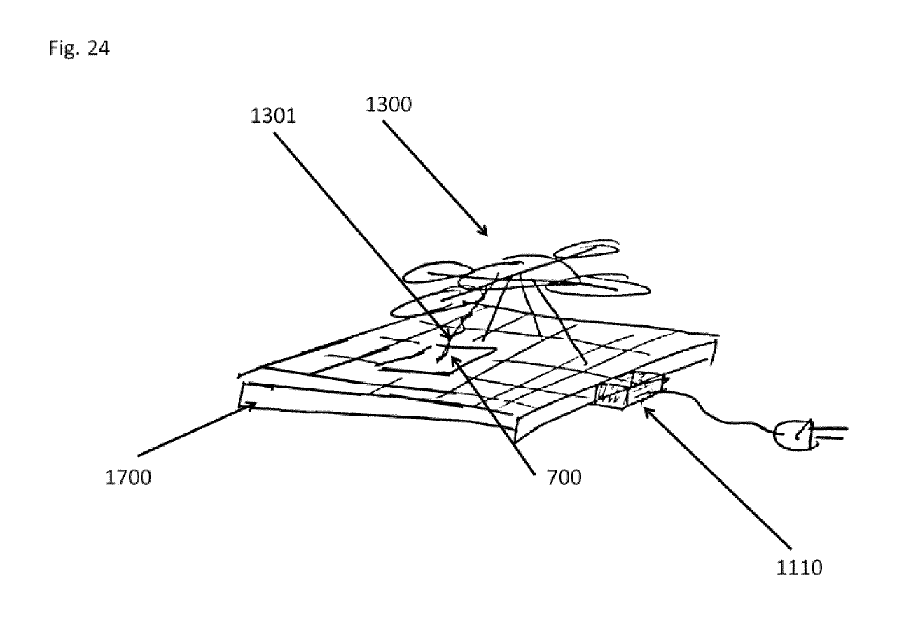

FIG. 23 shows for a further embodiment of the present invention, a surface 900 may comprise a tessellation of insulated conductive tiles 920, 930 each corresponding to a charger contact or primary contact. The conductive tiles may be activated dynamically. FIG. 23 illustrates a surface in accordance with certain embodiments of the present invention. The surface may correspond to a top surface.

Referring to FIG. 23, a gap may exist between the conductive tiles. The gap 910 may provide insulation e.g. by an insulator between the conductive tiles 920, 930.

In certain embodiments of the present invention, each conductive tile may be one type of a plurality of different types of conductive tiles. For example, in one embodiment, there may be nine different types of conductive tiles, and each conductive tile may correspond to one of these nine types. Other embodiments of the present invention may have more or less than nine types of conductive tiles. In certain embodiments of the present invention, the number of types of conductive tiles on the top surface may be constant and independent of the dimensions of the top surface. In other words, regardless of how large the surface is, the top surface may comprise tiles of a fixed number of types (such as nine types, for example), Each type of tile may be independently activated, thus resulting in groups of connected conductive tiles. At a given time, the tiles of a certain type may be activated together. For example, at a given time, the tiles of “type 1” (1001, 1002) may be activated together. See FIGS. 20 to 23.

With one embodiment of the present invention, the surface may comprise squared conductive tiles. Certain embodiments of the present invention may implement the surface using a minimum of nine independently-activated types of conductive tiles. This embodiment may implement nine groups of connected conductive tiles. FIGS. 20 to 23 illustrate this embodiment. The minimum number of types of activated conductive tiles may change with different shapes of conductive tiles.

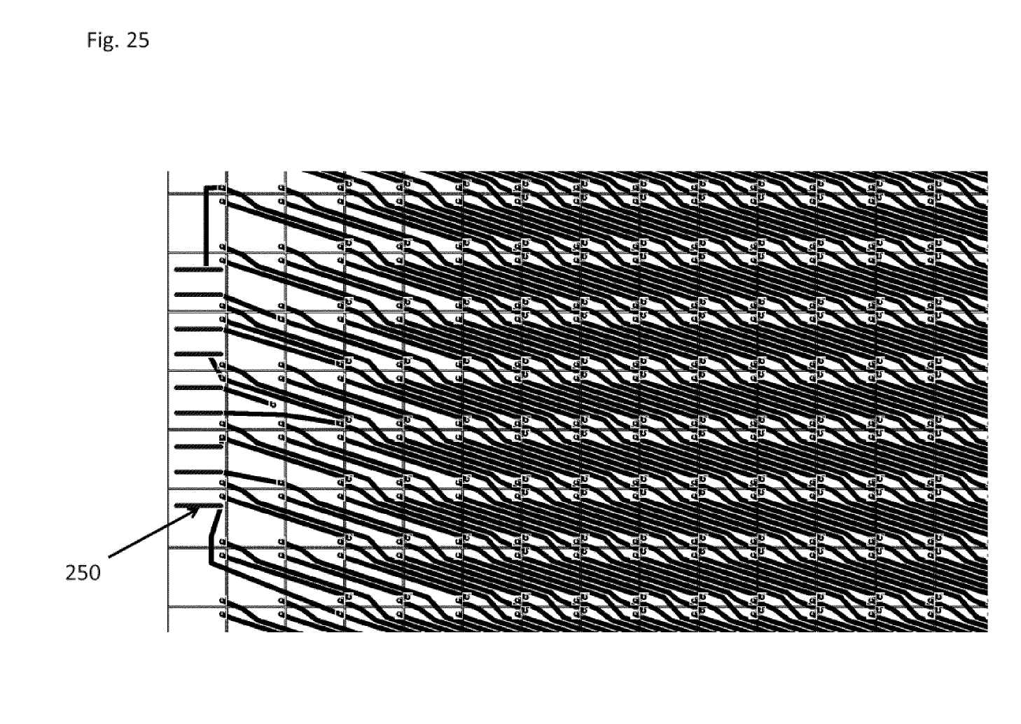

FIG. 24 provides an overview of a system in accordance with certain embodiments of the present invention. A drone 1300 with a plurality of legs 1301 may land on the charger pad. At least one leg 1301 of the plurality of legs may correspond to a square 700 (as shown by FIG. 21).

With certain embodiments of the present invention, a logic or control board 1110 of the charger pad may be connected to a socket on the border of the charger pad, as illustrated by FIG. 24. The logic or control board 1110 ensures power distribution to the charger pad. Further, control electronics are implemented in the control board 1110 for controlling the charger pad and the charging process of the drone 1300.

In certain embodiments of the present invention, a mobile electrical device may include a battery. The battery may be connected to an external battery charger.

In certain embodiments of the present invention, the logic board may continuously sense the socket contacts. The presence of current/resistance between a pair of socket contacts may indicate the presence of a battery charger, and the power supply may be activated on these two socket contacts. The battery charger may be an independent component that extends the capabilities of a mobile electrical device, such as UAVs/multicopters/drones that are to be charged by the charger pad.

The two input contacts of the battery charger may be installed on the exterior of the enclosure of the electrical device (i.e, the UAV, the drone). The two input contacts may be installed such that the distance between each of the input contacts is greater than the maximum distance between any pair of points of a given conductive tile, as illustrated by FIG. 20, 21 or 24. In one embodiment of the present invention, spring contacts may be utilized.

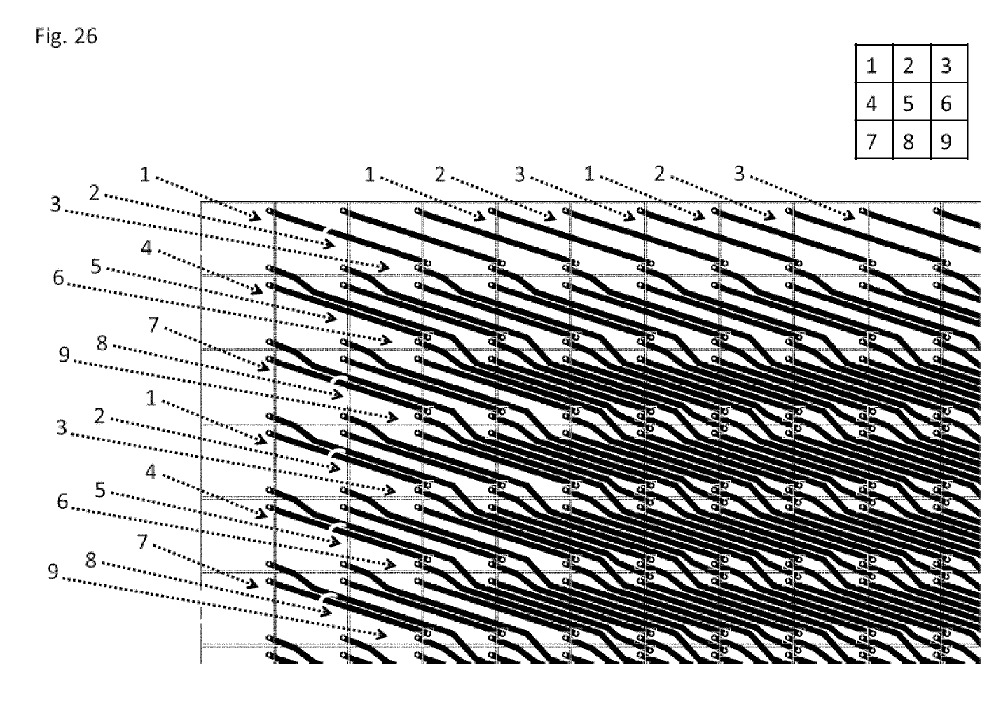

FIG. 25 illustrates nine contacts 250 on the left side of the square of a charger pad, according to certain embodiments of the present invention. The nine contacts may also be available on the bottom, left, and top sides to ensure that the charger pad may form/compose a wider charger pad. Respective bridge contacts as for example shown in FIGS. 18 and 19 are provided for electrically coupling to the nine contacts 250. The bridges may also couple pads to tiles mechanically. The control board 1110 may also be connectable to the contacts 250. The number of contacts depends on the number of groups of tiles.

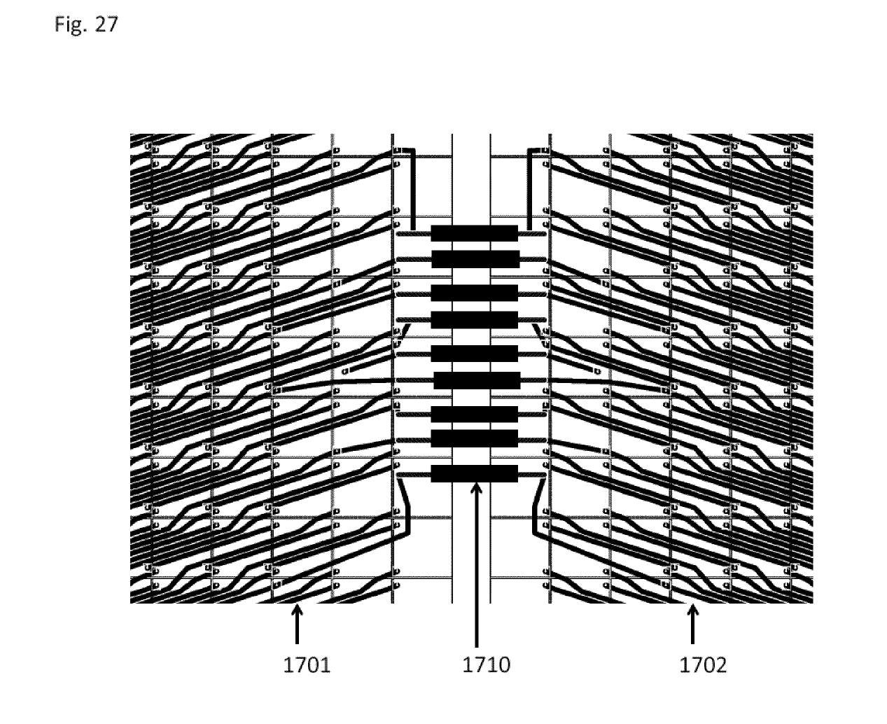

FIG. 26 illustrates an example configuration of redundant wiring according to certain embodiments of the present invention. The conductive tiles may be organized into nine different groups. The numbers 1-9 may show how the different groups are organized. Each tile may be connected to the other tiles in the same group by one, two, three or four wires, for example. The tiles on the center of the charger pad may be connected by four wires, and the tiles close to the border may be connected by one, two, or three wires, for example. The tiles are distributed in a repetitive pattern according to the tile group (number 1 to 9) they belong to.

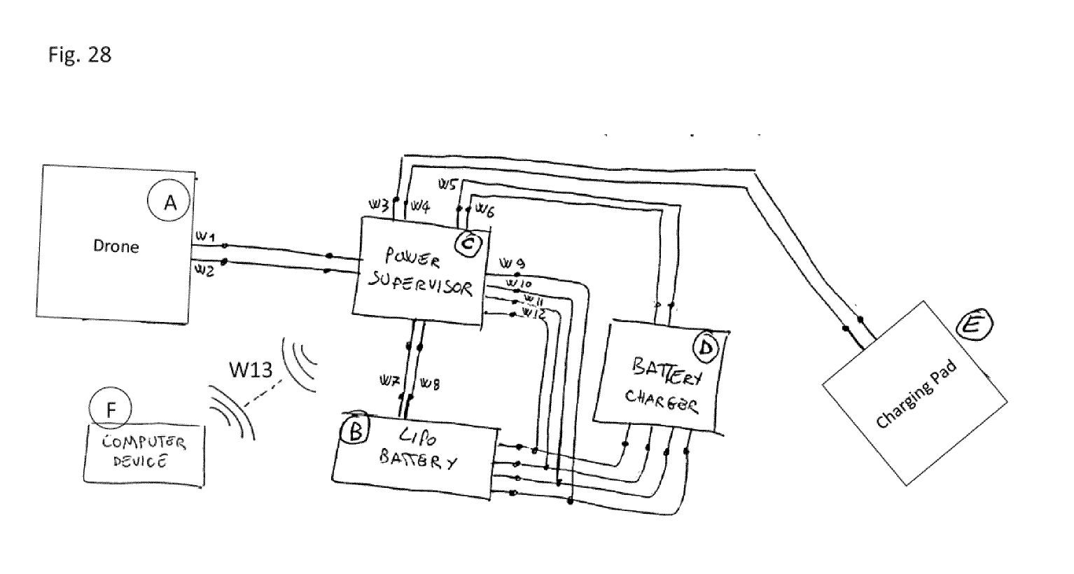

FIG. 27 illustrates two charger pads 1701, 1702 that are connected using nine contacts or a bridge 1710 on the left and right sides of two charger pads. Each of the contacts may correspond to a certain tile type. For example, nine contacts may correspond to nine different tile types. The black rectangles correspond to bridge contacts between the tiles in the same groups in the two charger pads. The two charger pads may constitute a wider charger pad or part of a wider charger pad.

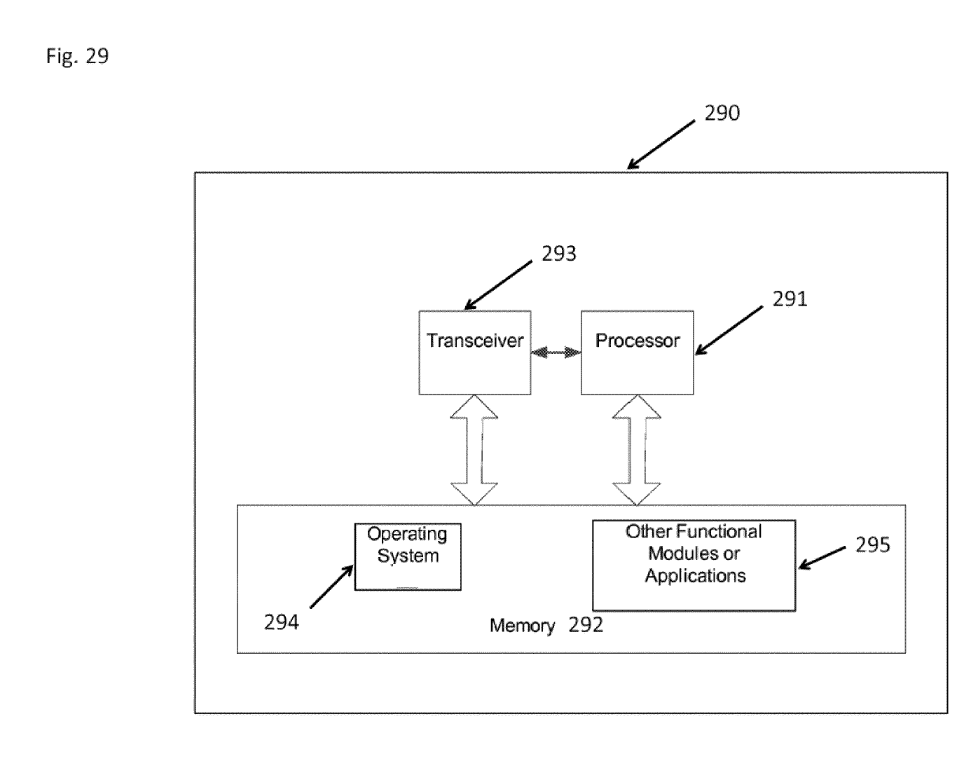

Referring to FIG. 28, components and wiring of the system are illustrated. A drone A may be a flying robot. Wires W1-2 provide the power supply to the drone A. A battery B is provided (such as a LiPo Battery, for example). LiPo batteries can have varying number of cells and voltages. LiPo batteries may be supported with 3, 4, 5 or 6 cells. The battery is a component of the drone. Wires W7-8 are the output power contacts of the battery. Wires W9-12 are the charge contacts for the individual battery cells. In this example, there are four wires for a 3-cell LiPo battery. To support up to 6s LiPo batteries, connectors with 4, 5, 6 or 7 contacts may be provided. A power supervisor C may be in charge of managing the power supply from the charger pad E and the battery B to the other devices. The power supervisor C may also provide monitoring measurements. The power supervisor C may be an independent component that may extend the capabilities of the drone. The power supervisor C may not be part of the drone and may not be part of the charger pad. The power supervisor C may be part or correspond to the control board 1110 of FIG. 24.

Wires W3-4 are the power supply to the power supervisor C from the charger pad E. Wires W5-6 provide power supply to the battery charger D. Battery charger D charges the battery B. The battery charger D may be an independent component that may extend the capabilities of the drone. Wires W5-6 provide power supply. Wires W9-12 are used to charge the 3-cells LiPo battery B. The charger pad E may be a device configured to provide the power supply to the power supervisor C through direct electrical contacts.

A computer device F can send and receive information from/to the power supervisor C. W13 is the wireless communication channel between the computer device and the power supervisor C. Bluetooth or any other technology can be used.

In the following an expected behavior by certain embodiments is explained:

If drone A lands or is on charger pad E then wires W3-4 provide power supply to the power supervisor C. The battery B continues to provide power supply to the drone A. The battery charger's D power supply W5-6 is turned OFF. The power supervisor C sends the voltage of battery or LiPo battery cells to the computer device F every 20 seconds (VDATA). The power supervisor C sends a battery temperature to the computer device F every 20 seconds (TDATA). The power supervisor C sends charging/not charging status to the computer device F every 20 seconds (CDATA). The power supervisor C waits for requests from the computer device F on wireless channel W13:

i. If power supervisor C receives a command to power OFF the drone A—CMD1: the power supply W1-2 is turned OFF.
ii. If power supervisor C receives command to power ON the drone using Battery—CMD2: W1-2 connected to W7-8.
iii. If power supervisor C receives command to power ON the drone using charger pad—CMD3: W1-2 is connected to W3-4.
iv. If power supervisor C receives command to power ON the charger—CMD4: W5-6 is connected to W3-4.
v. If power supervisor C receives command to power OFF the charger—CMD5: the power supply W5-6 is turned OFF.

If drone A is not on the charger pad E then the battery B provides power supply to the drone A and the power supervisor C is not powered, turned OFF.

In certain embodiments of the present invention, the input and output contacts of the battery charger, the input and output contacts of the battery, and the input contacts of the power supply of the mobile electrical device, may be connected to an electrical device referred to as the power supervisor. The battery may be a component of the mobile electrical device. The battery charger may be external or may be part of the mobile electrical device.

The power supervisor may activate or disable the power supply to the mobile electrical device, and the power supervisor may sense the status of the battery.

The power supervisor may receive commands and may send information using a low energy wireless channel or a different communication channel. The power supervisor can receive a command to power on or to power off the mobile electrical device. The power supervisor can receive a command to switch the power supply of the mobile electrical device from the battery to the charger pad. The power supervisor may receive the command to sense the status of the battery. The power supervisor can send information about the status of the battery, as illustrated by FIG. 28, for example.

The mobile electrical device may be stationing on the charger pad. The power supervisor may improve the lifetime of the battery by powering off the charger and the mobile electrical device when the mobile electrical device is left inactive on the charger pad. The power supervisor may receive a wakeup command to turn on the battery charger or to turn on the mobile electrical device. For example, a mobile electrical device can be a UAV/drone/multicopter.

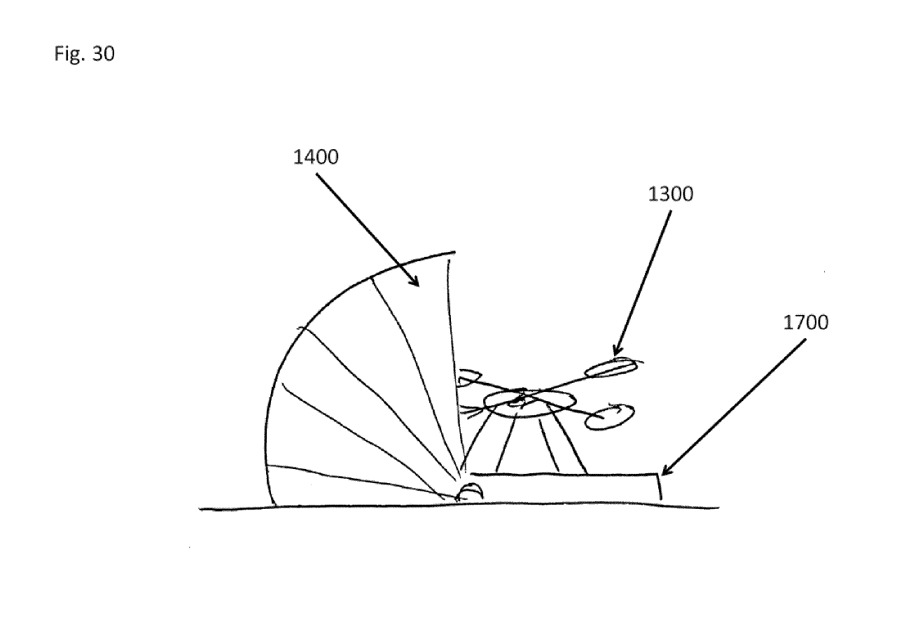

FIG. 29 illustrates an apparatus 290 according to embodiments of the invention. Apparatus 290 can be a component of a device, such as a drone/UAV, for example. In other embodiments, apparatus 290 can be a component of a charger pad, for example.

Apparatus 290 comprises a processor 291 for processing information and executing instructions or operations. Processor 291 can be any type of general or specific purpose processor. While a single processor 291 is shown in FIG. 29, multiple processors can be utilized according to other embodiments. Processor 291 can also comprise one or more of general-purpose computers, special purpose computers, micro processors, digital signal processors (DSPs), field-programmable gate arrays (FPGAs), application-specific integrated circuits (ASICs), and processors based on a multi-core processor architecture, as examples.

Apparatus 290 can further comprise a memory 292, coupled to processor 291, for storing information and instructions that can be executed by processor 291. Memory 292 can be one or more memories and of any type suitable to the local application environment, and can be implemented using any suitable volatile or nonvolatile data storage technology such as a semiconductor-based memory device, a magnetic memory device and system, an optical memory device and system, fixed memory, and removable memory. For example, memory 292 can be comprised of any combination of random access memory (RAM), read only memory (ROM), static storage such as a magnetic or optical disk, or any other type of non-transitory machine or computer readable media. The instructions stored in memory 292 can comprise program instructions or computer program code that, when executed by processor 291, enable the apparatus 290 to perform tasks as described herein.

Apparatus 290 can also comprise one or more antennas (not shown) for transmitting and receiving signals and/or data to and from apparatus 290. Apparatus 290 can further comprise a transceiver 293 that modulates information on to a carrier waveform for transmission by the antenna(s) and demodulates information received via the antenna(s) for further processing by other elements of apparatus 290. In other embodiments, transceiver 293 can be capable of transmitting and receiving signals or data directly.

Processor 291 can perform functions associated with the operation of apparatus 290 comprising, without limitation, precoding of antenna gain/phase parameters, encoding and decoding of individual bits forming a communication message, formatting of information, and overall control of the apparatus 290, comprising processes related to management of communication resources.

In certain embodiments, memory 292 stores software modules that provide functionality when executed by processor 291. The modules can comprise an operating system 294 that provides operating system functionality for apparatus 290. The memory can also store one or more functional modules 295, such as an application or program, to provide additional functionality for apparatus 290. The components of apparatus 290 can be implemented in hardware, or as any suitable combination of hardware and software.

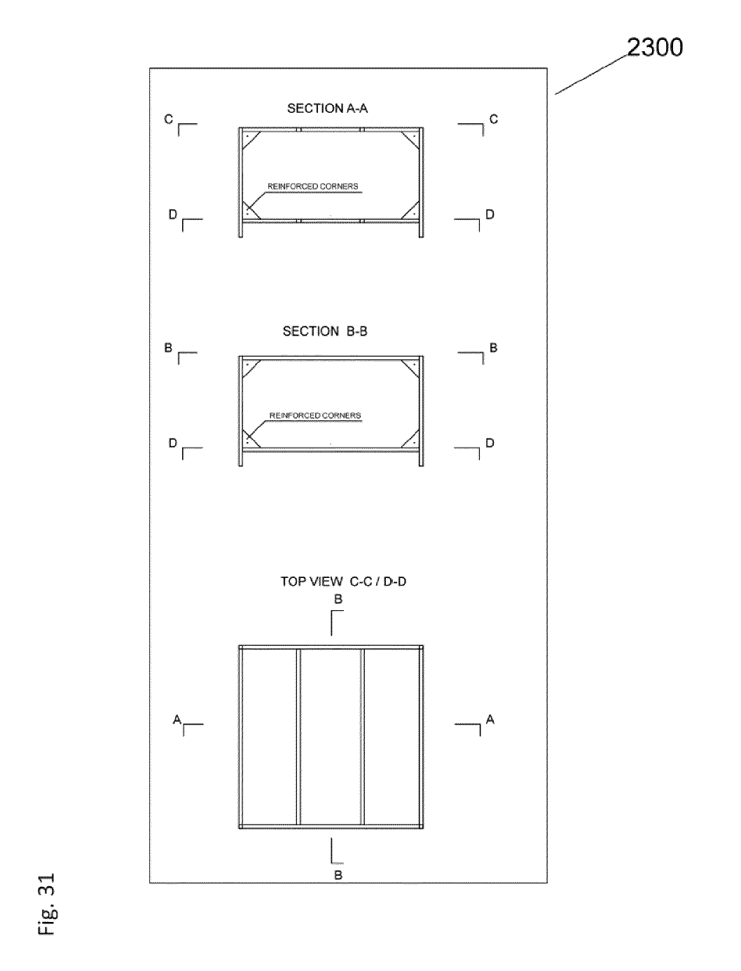

In certain embodiments of the present invention, the charger pad 1700 may be installed inside a remote-controlled enclosure 1400. The charger pad, the power supervisor, and the remote-controlled enclosure 1400 may constitute a remote-controlled and protected charger for flying robots 1300 (e.g., drones/UAVs/multicopters). One example of the remote-controlled enclosure 1400 is illustrated in FIG. 30. The remote-controlled enclosure 1400 comprises a retractable screen. The screen may fold into a storage position leaving the charger pad 1700 free for landing or take-off actions of the drone 1300. In a shelter position the screen encloses the drone 1300 and the charger pad 1700.

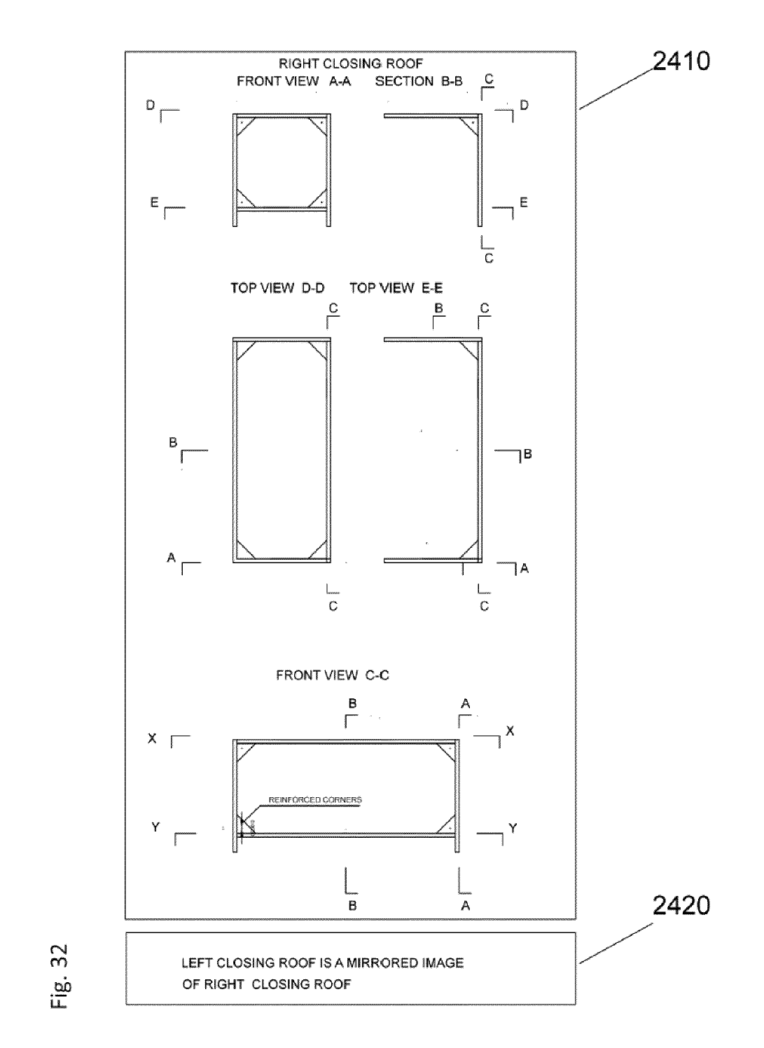

FIGS. 31 to 39 illustrate another example of a remote-controlled enclosure. The Remote-Controlled Enclosure is referred to as Drone Port from here on.

According to certain embodiments of the present invention, the Drone Port may be a shelter/enclosure for drones operating in unattended mode in remote areas. A drone may be stored inside the Drone Port and a charger pad may be installed on the internal floor to 1c) provide charging functionality. The Drone Port protects the drone from adverse weather conditions, humidity, wind, rain, dust, low and high temperatures. The Drone Port may comprise a safe remotely operated enclosure for stationing and charging the drone. FIGS. 31 to 39 detail the design and the mechanics of the Drone Port.

The Drone Port can be in “Open” position, “Closed” position or “Opening/closing” position.

The Drone Port may have no barriers when in “Open” position, facilitating the landing and takeoff procedures of the drone.

Mechanical components including gears, axles and connecting rods are safely protected inside the Drone Port when in “Closed” position. This reduces the possibility of faults due to snow, dust, or debris.

The design of the Drone Port may reduce the possibility that debris such as dust and leaves fall inside the Drone Port in the “Opening/closing” position. In the “Open” position, the drone may be expected to takeoff or land immediately. The Drone Port may be expected to be in “Closed” position most of the time.

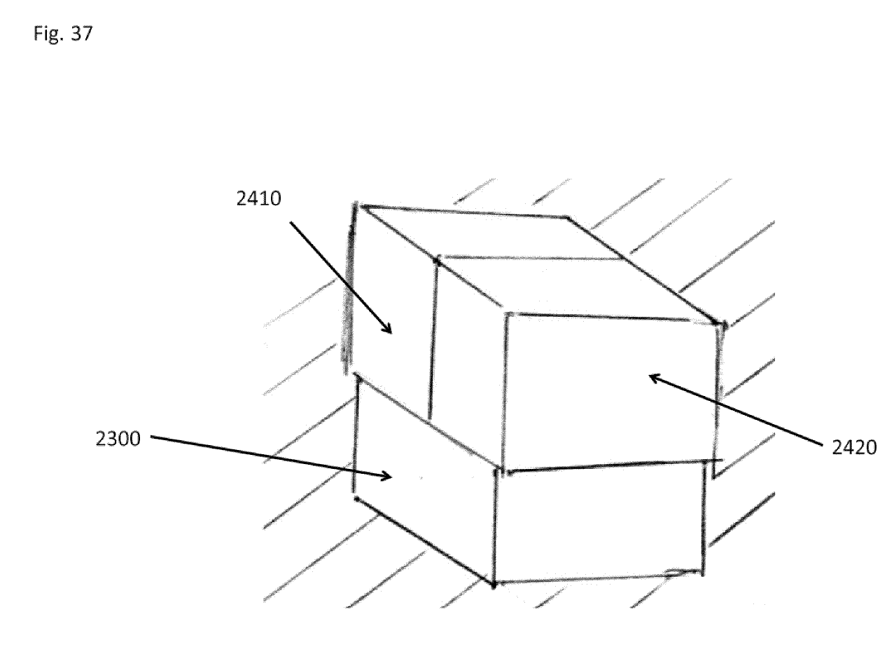

FIG. 37 shows the Drone Port in its “Closed” position in accordance with one embodiment. The Drone Port may comprise a platform 2300 and a moving roof. The roof may comprise two moving components (2410 and 2420) that can be moved apart to open the Drone Port. The two moving components are referred to as “half roofs” from here on.

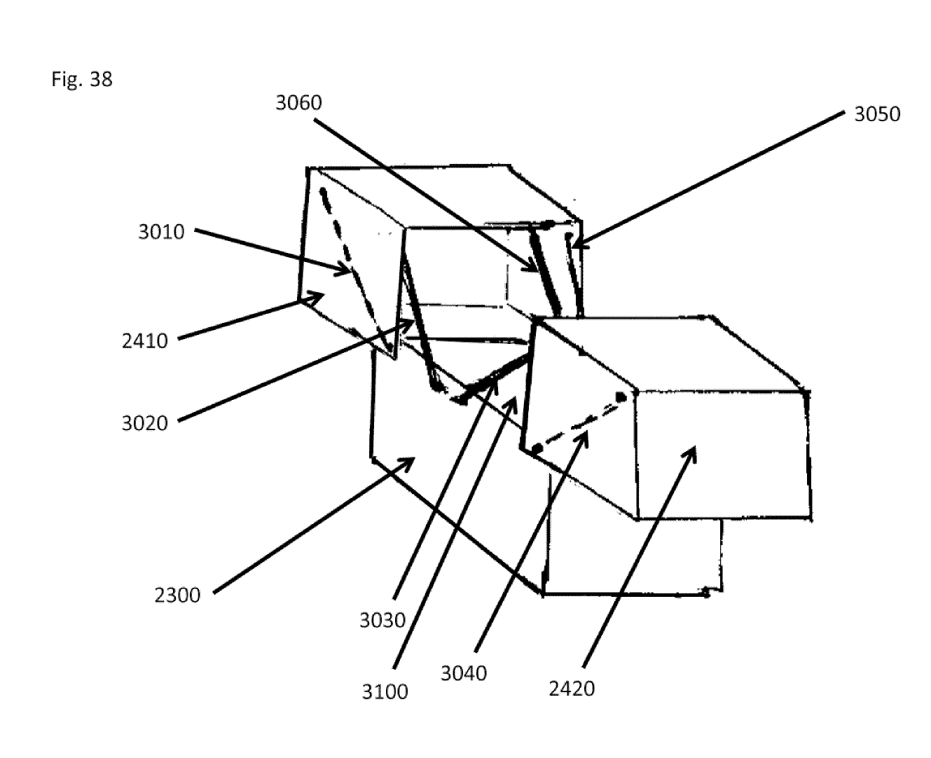

FIG. 38 shows the Drone Port in the “Opening/closing” position in accordance with one embodiment. The half roofs 2410 and 2420 move apart on a trajectory imposed by the connecting rods 3010, 3020, 3030, 3040, 3050 and 3060. A pair of connecting rods is not visible in FIG. 27. In total there may be four pairs of connecting rods (8 connecting rods).

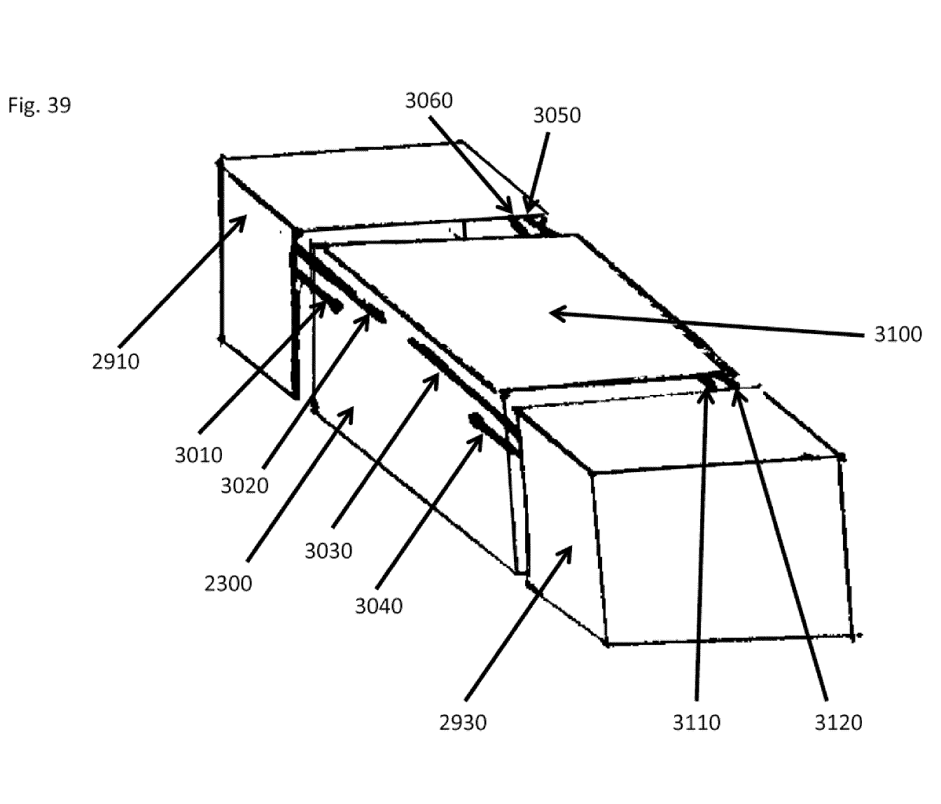

FIG. 39 shows the Drone Port in the “Open” position in accordance with one embodiment. All 8 connecting rods 3010, 3020, 3030, 3040, 3050, 3060, 3110 and 3120 are visible in FIG. 39. The half roofs may be flat and when in “Closed” position the Drone Port may have a cubic shape. The cubic shape is merely one possible shape. The structure of the Drone Port can be realized with other geometric shapes such as semi-domes or other forms depending on the use case and deployment requirements.

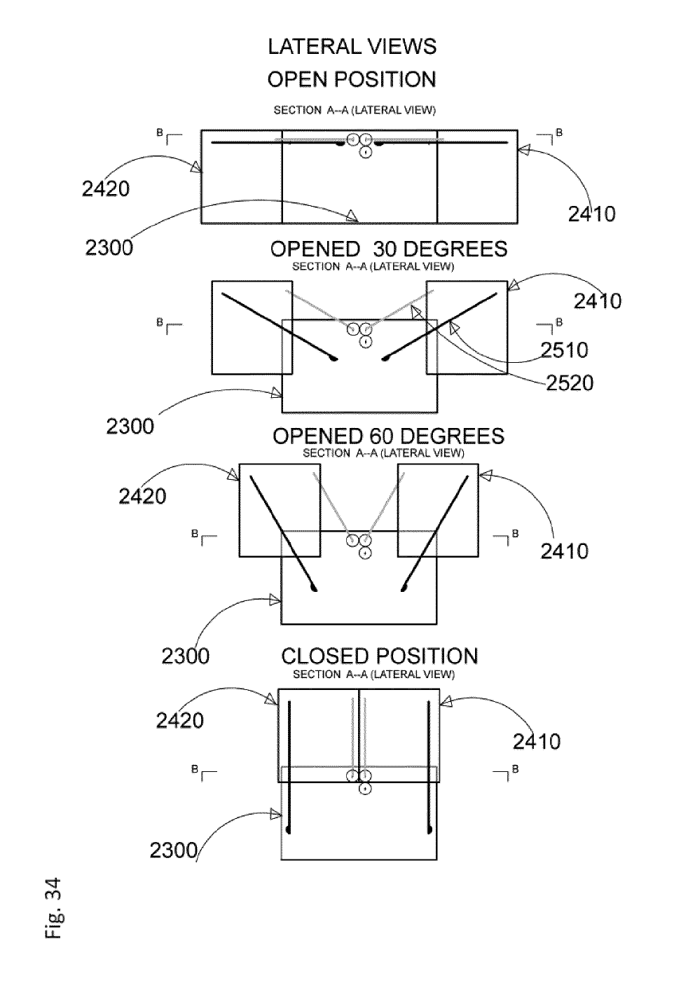

FIG. 34 shows the lateral views of the Drone Port in accordance with one embodiment. In FIG. 34 The two half roofs 2410 and 2420 may rotate moving down at the level of the platform 2300. The top flat surface may have no obstacles and may be a convenient surface for landing a drone.

The structure of the Drone Port in FIGS. 31 and 32 may comprise insulated metal or plastic frames.

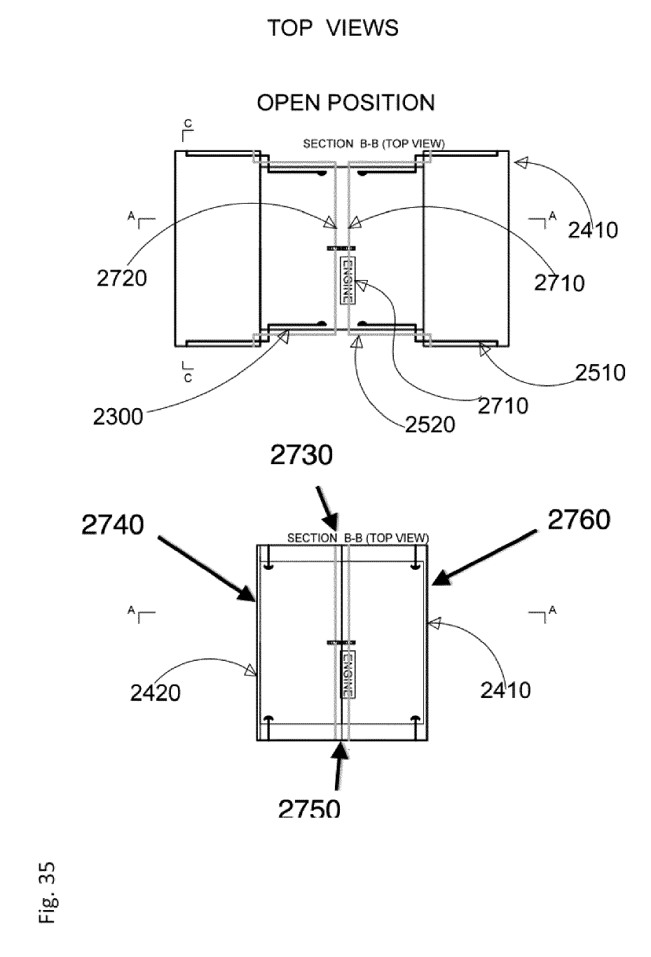

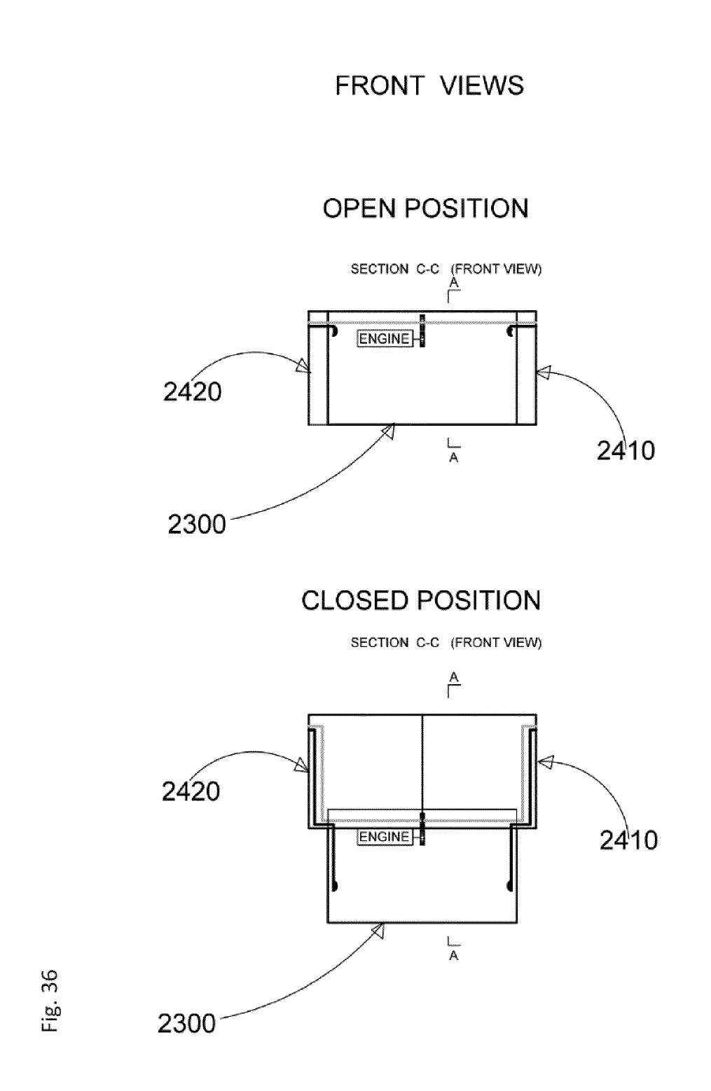

The two half roofs 2410 and 2420 may be slightly bigger than the platform 2300 to provide additional space for the connecting rods (see front and top views in FIGS. 35 and 36).

The mechanic movement of each half roof may be performed on two sides 2730 and 2750 of the Drone Port as shown in FIG. 35. Sides 2740 and 2760 do not have mechanical components.

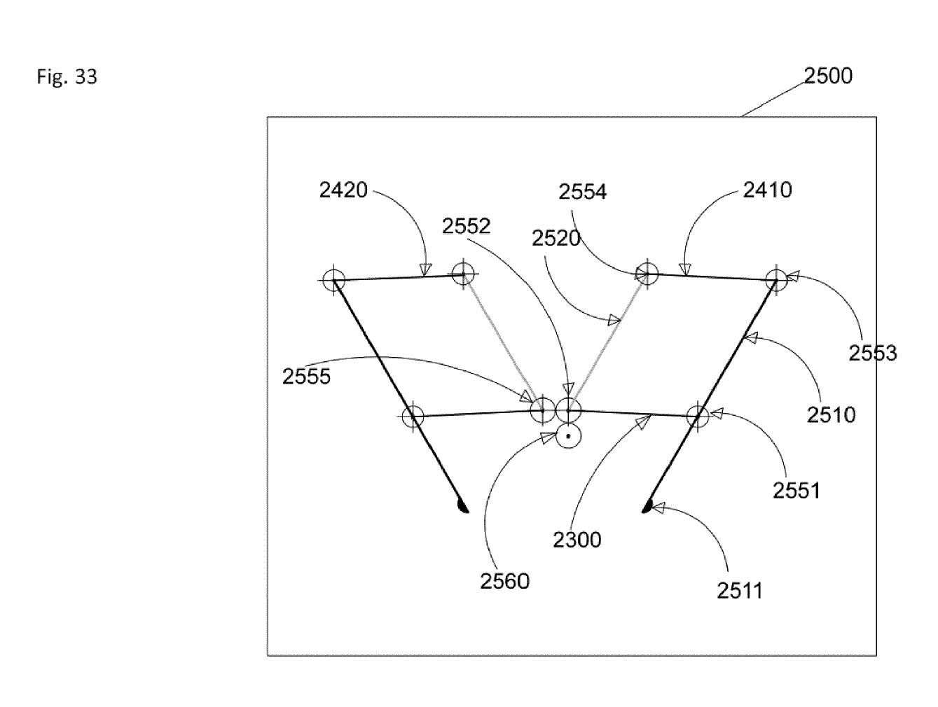

The mechanic movement of each half roof may be performed with two parallelograms. FIG. 33 shows a pair of parallelograms that represent the parallelograms present on one of the two sides of the Drone Port with connecting rods. For example, side 2730. The parallelograms may be connected to the platform 2300 and the half roofs 2410 and 2420 with connecting rods. With a pair of parallelograms on side 2730 and a second pair of parallelograms on side 2750, there may be a total of four parallelograms.

The two parallelograms of each rotating half roof may be connected together with two axles 2710 and 2720 as shown in FIG. 35.

Each parallelogram may be composed of two connecting rods. One of the two connecting rods in each parallelogram, i.e., 2510, may extend beyond the hinge and may have a weight 2511 that is used to balance the weight of the half roof as shown in FIG. 33. The weight reduces the mechanical torque required to open and close the two half roofs. The reduced mechanical torque allows the use of one low-power electrical motor to move the half roofs. Photovoltaic panels, wind turbines or other power sources can power the low-power electrical motor.

Photovoltaic panels can be installed on the exterior of the Drone Port.

The Drone Port opening and closing may be achieved with a low-power electric engine (FIG. 35) that may be powered by a battery charged using the photovoltaic panels installed on the roof and/or on the lateral sides of the Drone Port, depending from the deployment. The same battery can also be used to power the charger pad installed on surface 3100 in FIG. 39 and for internal conditioning/heating.

The balancing extension of connecting rod 2510 (segment from 2551 to 2511) may be internal to the platform 2300 while the other components of the parallelogram may be 1) external to the platform 2300, and 2) internal to the half roofs 2410 and 2420, 3) and contained in the space between the platform and the half roofs.

The external part of the connecting rod 2510 (segment from 2551 to 2553) may be connected with its internal part (segment from 2551 to 2511) with a hub rotating on bushings or bearings 2551. The other connecting rod 2520 of each parallelogram, on his axle 2552, may have a gear connected to the gear 2560 coaxial with the low-power electrical motor 2710 reported in FIG. 35.

In FIG. 33, on the same axle 2552 a second gear may be connected with gear 2555 on the corresponding axle of the other half roof to move it synchronously. The description of the gear group and the connection with the low-power electrical motor is merely one example implementation and can also be built with other types of coupling like contact wheels, rubber straps, chain and sprockets, endless worm.

The low-power electrical motor that operates the opening and closing of the Drone Port may be driven by local or remote commands.

1. Charging apparatus for electrically charging rechargeable energy storage devices a mobile consumer, comprising a plurality of area-wise distributed primary contacts which are insulated against each other or against neighboring primary contacts and are connectable with at least two counter contacts, wherein the primary contacts are connected with a control unit and electrical switches for wiring into a right polarity for the charging process.

2. Charging apparatus according to claim 1, wherein the primary contacts are charger contacts and the counter contacts are consumer contacts.

3. Charging apparatus according to claim 2, wherein the consumer contacts comprise a point-like or different shape and wherein a thickness of the insulation between the extensive charger contacts may be smaller than the maximum distance between any two points on the surface of the contact area of the consumer contacts.

4. Charging apparatus according to claim 1, wherein the control unit comprises a micro processor which is connected with the electrical switches, a power supply and at least one of a half bridge, a current sensor and a light emitting diode.

5. Charging apparatus according to claim 1, wherein the charging apparatus is a charger pad and the mobile consumer is an unmanned aerial or ground vehicle.

6. Charging apparatus according to claim 1, further comprising means for at least one of cleaning, detection, attachment, marking and optical identification of an active area of the charging apparatus.

7. Charging apparatus according to claim 1, wherein the primary contacts comprise a rectangle, triangle, square or hexagonal shape.

8. Charging apparatus according to claim 1, wherein the mobile consumer includes a rectifier or a reverse voltage protection circuit.

9. Charging apparatus according to claim 1, wherein the primary contacts comprise different types of conductive tiles and wherein conductive tiles of each type are electrically connected to each other.

10. Charging apparatus according to claim 1, wherein the charging apparatus is a charger pad, wherein a wider charger pad is composed of a plurality of charger pads, wherein a charger pad comprises contact sockets and wherein bridging contacts connect the contact sockets.

11. Charging apparatus according to claim 10, wherein the charger pad has a square or a rectangle, triangle or hexagonal shape with one contact socket arranged on each side.

12. Charging apparatus according to claim 1, further comprising an enclosure or a remote controlled enclosure adapted for enclosing a mobile consumer located on the charging apparatus and/or wherein the remote controlled enclosure comprises at least one, preferably two retractable roof parts.

13. Method for electrically charging rechargeable energy storage devices of a mobile consumer comprising the steps of:
connecting at least two out of a plurality of area-wise distributed primary contacts which are insulted against each other or against neighboring area-wise distributed primary contacts with at least two counter contacts of the mobile consumer,
detecting of connected primary contacts which are to be activated,
activating of selected primary contacts and wiring of a charging voltage having the right polarity,
initiating and performing the charging process.

14. Method according to claim 13, wherein the primary contacts are charger contacts and the counter contacts are consumer contacts and wherein detection of primary contacts which are to be activated is realized by monitoring of a current consumption such that
for a current flow below a set current range no charging process is initiated,
for a current flow above a set current range a charging process is initiated,
for a current flow above (overload) a set current range it is switched to a next configuration of contacts
and/or
wherein the detection of completed charging process is realized by monitoring of a derivative value of a current consumption such that for a derivative value below a set threshold the charging process is considered completed and furthermore, the current consumption may be pre-processed using a moving average or equivalent filter before computing the derivative values to level out noise and anomalies

15. System for electrically charging an energy storage device of a mobile consumer comprising a charging apparatus according to claim 1, a charger for energy storage devices, and a power supervisor adapted for managing power supply from the charging apparatus and the energy storage device to the mobile consumer and/or for monitoring at least one the energy storage device, the charging apparatus, the charger of the energy storage device, and the mobile consumer.
